(19) United States
(12) Patent Application Publication
(10) Pub. No.: US 2004/0125396 A1
(43) Pub. Date: Jul. 1, 2004

(54) System and method for routing voice/video/fax mail

(76) Inventor: James Burke, Old Bridge, NJ (US)

Correspondence Address: Richard C. Litman, LITMAN LAW OFFICES, LTD., P.O. Box 15035, Arlington, VA, 22215, US

(21) Appl. No.: 10/736,587

(22) Filed: Dec. 17, 2003

Related U.S. Application Data
(60) Provisional application No. 60/434,431, filed on Dec. 19, 2002.

(51) Int. Cl. H04N 1/00; G06F 15/00; H04N 1/44

(52) U.S. Cl. 358/1.13; 358/400; 358/1.15; 358/468

(57) ABSTRACT

A fax machine for a system and/or method for routing voice/video/fax mail includes a processor and memory, and the fax machine is configured for routing voice/video/fax mail to associated recipients. The fax machine includes an operating panel, an operating display screen, a microphone/speaker, a telephone handset, a sealed paper tray, an auxiliary paper tray, a printer, an audio/video recording camera, a voice/video/fax mail display monitor, a modem, a processor, memory, and a communication bus which interconnects of the elements of the fax machine. The fax machine may also include an additional key pad, PCI slots, voice generator circuitry, voice recognition circuitry, a sound card, a paper scanner, a bar code reader, a finger/thumb print scanner, a retina scanner, a stylus pen, a signature pad, a shredder, a hard drive, and/or a removable drive.

### CROSS-REFERENCE TO RELATED APPLICATIONS

This application claims the benefit of U.S. patent application Ser. No. 10/443,740, filed May 23, 2003, and U.S. Provisional Patent Application Serial No. 60/434,431, filed Dec. 19, 2002, each of which is incorporated herein by reference.

### BACKGROUND OF THE INVENTION

1. Field of the Invention

The present invention relates to facsimile (fax) machines and, more particularly, to a system and/or method for routing voice/video/fax mail, and insuring fax security.

2. Description of the Related Art

Fax machines emerged from humble, error-filled seven minutes per page beginnings to modern times where fax machines are found in almost every office and are capable of sending or receiving several pages per minute. Fax machines are endemic in today's workplace because they are easy to use and have become a well-accepted form of communication.

Unfortunately, fax machines do have several shortcomings, the first of which is the lack of a routing capability. When a fax is sent, it ordinarily prints out on the receiving machine and remains in the printout tray. While this may not be a problem in some offices, whenever more than one person relies on the same fax machine, documents can get lost in the shuffle and not reach their intended target.

Fax machine security is also a drawback of traditional fax machines. Without a routing or security capability, faxed documents may be read by anyone who happens to be near the fax machine when a fax is transmitted. In this way sensitive information may be inadvertently revealed.

Several attempts have been made to overcome the aforementioned problems, but none do so in a manner as simple and as effective as the present invention.

The related art is represented by the following references of interest.

U.S. Patent Application Publication No. 2002/0033961 A1, published on Mar. 21, 2002 for Frederick J. Murphy, describes a method and apparatus for securely transforming and transmitting electronic information from one protocol form for delivery over a packet-switched network. The Murphy application does not suggest a system and/or method for routing voice/video/fax mail according to the claimed invention.

U.S. Patent Application Publication No. 2002/0036794 A1, published on Mar. 28, 2002 for Bernhard Boehmer et al., describes a method and apparatus for central coordination of data transmission between a transmitting and a receiving network element. The Boehmer et al. application does not suggest a system and/or method for routing voice/video/fax mail according to the claimed invention.

U.S. Pat. No. 6,188,488, issued on May 9, 2002 for Masashi Eguchi, describes a fax server or an electronic mail device, which is connected to an electronic mail server, including means for referring for size of electronic mail which is addressed to the fax server or the electronic device and which reached the electronic mail server, and comparing the size of this incoming electronic mail with receivable size. The Eguchi patent does not suggest a system and/or method for routing voice/video/fax mail according to the claimed invention.

U.S. Patent Application No. 2002/0075539 A1, published on Jun. 20, 2002 for Shane Konsella et al., describes a system and/or method for routing a communication original directed to an original destination to a secondary destination. The Konsella et al. application does not suggest a system and/or method for routing voice/video/fax mail according to the claimed invention.

U.S. Patent Application Publication No. 2002/0080415 A1, published on Jun. 27, 2002 for Naoto Akimoto et al., describes a communication apparatus for forwarding received data as electronic mail, a control method thereof, and a storage medium storing a program for controlling the communication apparatus. The Akimoto et al. application does not suggest a system and/or method for routing voice/video/fax mail according to the claimed invention.

U.S. Patent Application Publication No. 2002/0085745 A1, published on Jul. 4, 2002, and U.S. Pat. No. 6,363,164 B1, issued on Mar. 26, 2002 for John E. Jones et al., describe a document and currency processing system capable of processing documents utilizing full image scanning and a currency discriminator. The Jones et al. application and patent do not suggest a system and/or method for routing voice/video/fax mail according to the claimed invention.

U.S. Patent Application Publication No. 2002/0101620 A1, published on Aug. 1, 2002 for Imran Sharif et al., describes a fax machine that provides paperless operations and that utilizes the capabilities of a network server to store and archive data. The Sharif et al. application does not suggest a system and/or method for routing voice/video/fax mail according to the claimed invention.

U.S. Patent Application Publication No. 2002/0149644 A1, published on Oct. 17, 2002 for Rodolfo Jodra et al., describes a final-hardcopy operating facility that converts the content provider's original data file to a different color space to form a proofing data file. The Jodra et al. application does not suggest a system and/or method for routing voice/video/fax mail according to the claimed invention.

U.S. Pat. No. 4,010,466, issued on Mar. 1, 1977 to Steven R. Hofstein, describes a method and system of electronic image storage and display wherein the display is viewed on a raster scan television display and the incoming signal includes a sequence of scan lines whose line rate is lower than that of the horizontal television line rate within a field of the television display and is an odd integer submultiple thereof. The Hofstein patent does not suggest a system and/or method for routing voice/video/fax mail according to the claimed invention.

U.S. Pat. No. 4,769,719, issued on Sep. 6, 1988 to Etsuro Endo, describes a fax system with a memory unit for storing video information read from a document that is laser scanned on the receiving side that then enables the transmitting side to confirm transmission receipt. As the transmitting side demands a recording confirmation response, the receiving side prepares its response confirming the receipt of the document. A fax master controller serves to coordinate the communications, print, and video operations between both the sending and receiving machines. The Endo patent does not suggest a system and/or method for routing voice/video/fax mail according to the claimed invention.

U.S. Pat. No. 4,888,812, issued on Dec. 19, 1989 to Raymond F. Dinan et al., describes a document image processing system. The Dinan et al. patent does not suggest a system and/or method for routing voice/video/fax mail according to the claimed invention.

U.S. Pat. No. 5,170,252, issued on Dec. 8, 1992 to Gary Gear et al., describes a system and method for interconnecting and mixing multiple audio and mixing multiple audio and video data streams associated with multiple media devices. The Gear et al. patent does not suggest a system and/or method for routing voice/video/fax mail according to the claimed invention.

U.S. Pat. No. 5,333,068, issued on Jul. 26, 1994 to Masamori Sakai et al., describes an image processing system. The Sakai et al. patent does not suggest a system and/or method for routing voice/video/fax mail according to the claimed invention.

U.S. Pat. No. 5,587,809, issued on Dec. 24, 1996 to Hervé Le Corre et al., describes a system and process for sending secure faxes that include a sending fax machine, a receiving fax machine, and a registered fax server. The Le Corre et al. patent does not suggest a system and/or method for routing voice/video/fax mail according to the claimed invention.

U.S. Pat. No. 5,602,936, issued on Feb. 11, 1997 to W. Thomas Green et al., describes a method and apparatus for recapturing data from scanning devices and storing the captured data in digital form. The Green et al. patent does not suggest a system and/or method for routing voice/video/fax mail according to the claimed invention.

U.S. Pat. No. 5,619,725, issued on Apr. 8, 1997 to Alastiar T. Gordon, describes a method and apparatus for retrieval of information from a remote computer by a personal computer (PC) equipped with a fax modem where the PC initiates the communication. The Gordon patent does not suggest a system and/or method for routing voice/video/fax mail according to the claimed invention.

U.S. Pat. No. 5,644,404, issued on Jul. 1, 1997 to Shin'ichi Hashimoto et al., describes a fax server system in which a computer terminal or fax server terminal which receives and stores fax data is interconnected via a network with another computer terminal or client terminal which accesses the fax data stored in the fax server through the network, and in which at the time when the received fax data is accessed for the first time by the client terminal, the fax server terminal transmits, as response data, data acknowledging receipt of the fax data to a source terminal having sent the same. The Hashimoto et al. patent does not suggest a system and/or method for routing voice/video/fax mail according to the claimed invention.

U.S. Pat. No. 5,774,879, issued on Jun. 30, 1998 to Jeanne M. Custy et al., describes an automated financial instrument processing system. The Custy et al. patent does not suggest a system and/or method for routing voice/video/fax mail according to the claimed invention.

U.S. Pat. No. 5,872,637, issued on Feb. 16, 1999 to Hiroyuki Nakanishi, describes an image communication system in which data stored in a memory are accessible in convenient manner from a remote location. The Nakanishi patent does not suggest a system and/or method for routing voice/video/fax mail according to the claimed invention.

U.S. Pat. No. 6,114,116, issued on Oct. 31, 2000 to Gregory G. Odom et al., describes a method and system for confidential transmissions of documents over existing telephone communications lines that generates encrypted documents suitable for reception by a fax machine. The Odom et al. patent does not suggest a system and/or method for routing voice/video/fax mail according to the claimed invention.

U.S. Pat. No. 6,157,464, issued on Dec. 5, 2000 to Mark C. Bloomfield et al., describes a fax store and forward system including a local interface and a remotely located fax store and forward facility which cooperate to perform a host of fax service methods. The Bloomfield et al. patent does not suggest a system and/or method for routing voice/video/fax mail according to the claimed invention.

U.S. Pat. No. 6,181,837 B1, issued on Jan. 30, 2001 to Thomas Cahill et al., describes a method and apparatus for storing and retrieving images of documents. The Cahill et al. patent does not suggest a system and/or method for routing voice/video/fax mail according to the claimed invention.

U.S. Pat. No. 6,204,929 B1, issued on Mar. 20, 2001 to Tokunori Kato, describes a transmission device capable of preventing erroneous operations from being performed because of external light intruding into the transmission device. The Kato '929 patent does not suggest a system and/or method for routing voice/video/fax mail according to the claimed invention.

U.S. Pat. No. 6,330,079 B1, issued on Dec. 11, 2001 to Andrew J. Dugan et al., describes an integrated voicemail and faxmail platform for a communications systems. The Dugan et al. patent does not suggest a system and/or method for routing voice/video/fax mail according to the claimed invention.

U.S. Pat. No. 6,363,360 B1, issued on Mar. 26, 2002 to Martin P. Madden, describes a system and method for analyzing and originating a contractual option arrangement for transacting a deposit liabilities base of a financial institution at predetermined prices and time periods. The Madden patent does not suggest a system and/or method for routing voice/video/fax mail according to the claimed invention.

U.S. Pat. No. 6,366,892, issued on Apr. 2, 2002 to Charles J. Altman, describes a method for automating legal documents particularly for institutional and commercial loans. The Altman patent does not suggest a system and/or method for routing voice/video/fax mail according to the claimed invention.

Germany Patent Application Publication No. 3,733,650 A1, published on Apr. 14, 1988, describes a message transmission system. The Germany '650 application does not suggest a system and/or method for routing voice/video/fax mail according to the claimed invention.

Japan Patent Application Publication No. 2-82740, published on Mar. 23, 1990, describes a fax store and forward exchange. The Japan '740 application does not suggest a system and/or method for routing voice/video/fax mail according to the claimed invention.

Japan Patent Application Publication No. 3-6149, published on Jan. 11, 1991, describes a subscriber individual multiple address list registering system for fax store and forward exchange device. The Japan '149 application does not suggest a system and/or method for routing voice/video/fax mail according to the claimed invention.

Japan Patent Application Publication No. 5-180620, published on Jul. 23, 1993, describes an image processing method. The Japan '620 application does not suggest a system and/or method for routing voice/video/fax mail according to the claimed invention.

None of the above inventions and patents, taken either singly or in combination, is seen to describe the instant invention as claimed.

### SUMMARY OF THE INVENTION

The present invention is a system and/or method for routing voice/video/fax mail. A fax machine according to the invention includes a processor and memory, and the fax machine is configured for routing voice/video/fax mail to associated recipients. The fax machine includes an operating panel, an operating display screen, a microphone/speaker, a telephone handset, a sealed paper tray, an auxiliary paper tray, a printer, an audio/video recording camera, a voice/video/fax mail display monitor, a modem, a processor, memory, and a communication bus which interconnects the elements of the fax machine. The fax machine may also include an additional key pad, peripheral component interconnect (PCI) slots, voice generator circuitry, voice recognition circuitry, a sound card, a paper scanner, a bar code reader, a finger/thumb print scanner, a retina scanner, a stylus pen, a signature pad, a shredder, a character generator, a network control unit, input/output ports, a hard drive, a removable drive, and/or an antenna.

The fax machine includes an enlarged memory capable of storing a plurality of transmitted voice/video/fax mail, and a routing/security protocol capable of selectively disseminating the transmitted voice/video/fax mail to select users. The security protocol also provides for a system whereby the fax sender may access the receiving fax machine in order to determine whether voice/video/fax mail has been received and accessed by an intended recipient.

The system may also include a network card through which a sending and/or receiving fax machine according to the invention may be connected to a wide area and/or local area network connection. Through the network connection, voice/video/fax mail stored in the memory of the receiving fax machine may be accessed by remote computers. A sending fax machine may transmit instructions to cause the receiving fax machine to forward a copy of a voice/video/fax mail to a remote computer.

Finally the system may include security protocols capable of working with specially designed fax paper to allow for the secure faxing of negotiable instruments, and particularly, checks.

Accordingly, it is a principal aspect of the invention to provide a fax machine for routing voice/video/fax mail that includes a processor and memory, and wherein the fax machine is configured for routing voice/video/fax mail to associated recipients.

It is another aspect of the invention to provide a fax system having security features which insure that only the intended fax recipient may receive a voice/video/fax mail.

It is a further aspect of the invention to provide a fax system which allows the fax sender to access the recipient device in order to determine whether a particular voice/video/fax mail has been received and accessed by the intended recipient.

Still another aspect of the invention is to provide a fax system which may be used to fax checks with security.

Another aspect of the present invention is to allow for voice/video/fax mail stored in the memory of the recipient fax machine to be accessed by computer.

It is an aspect of the invention to provide improved elements and arrangements thereof in a system and/or method for routing voice/video/fax mail for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental view of a personalized fax system for routing voice/video/fax mail according to the present invention.

FIG. 2 is a block diagram of a personalized fax system for routing voice/video/fax mail according to the present invention.

FIG. 3 is a block diagram of the modes associated with a personalized fax system for routing voice/video/fax mail according to the present invention.

FIG. 4 is a flow chart of a method of routing voice/video/fax mail from a sending fax machine according to the present invention.

FIG. 5 is a flow chart of a method of routing voice/video/fax mail for a receiving fax machine according to the present invention.

FIG. 6 is a flow chart of a method of receiving and giving further instructions to a fax machine to either print or save voice/video/fax mail according to the present invention.

FIG. 7 is an environmental view of a routing system for voice/video/fax mail according to the present invention.

FIG. 8 is a flow chart of a method of remotely accessing voice/video/fax mail from a fax machine according to the present invention.

FIG. 9 is a flow chart of a method of a sender confirming that a recipient has retrieved a voice/video/fax mail according to the present invention.

FIG. 10 is an example of check faxing paper according to the present invention.

FIG. 11 is a flow chart of method of securely faxing a check for a receiving fax machine according to the present invention.

FIG. 12 is a flow chart of a method of securely faxing a check for a sending fax machine according to the present invention.

Similar reference characters denote corresponding features consistently throughout the attached drawings.

### DETAILED DESCRIPTION OF THE PREFERRED EMBODIMENTS

The present invention is a system and/or method for routing voice/video/fax mail. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

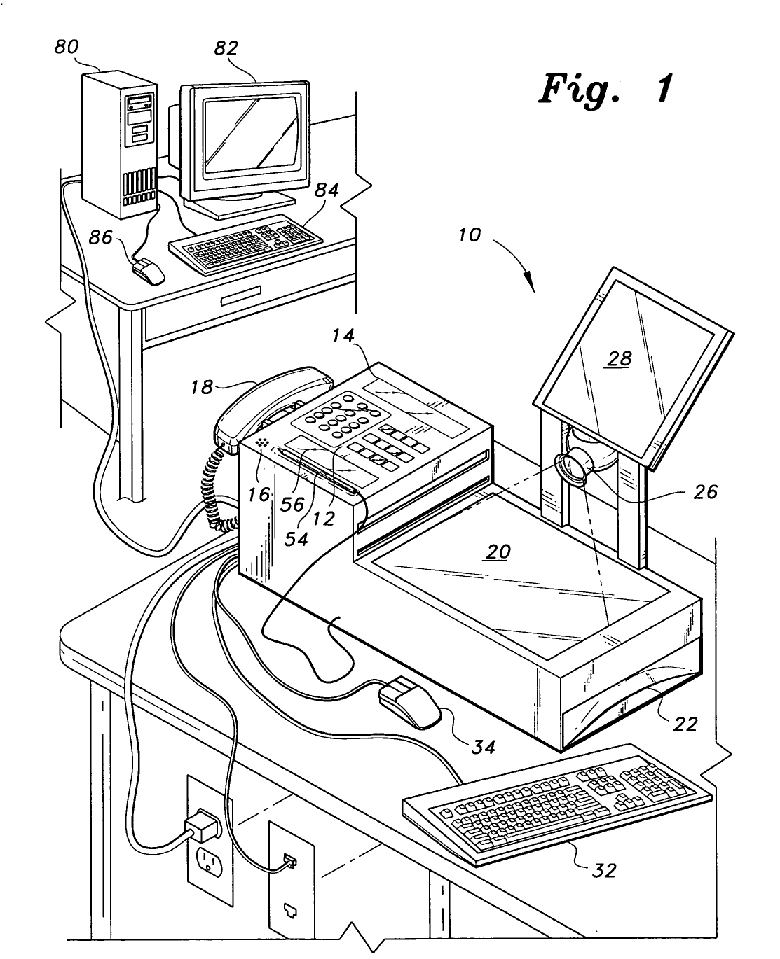

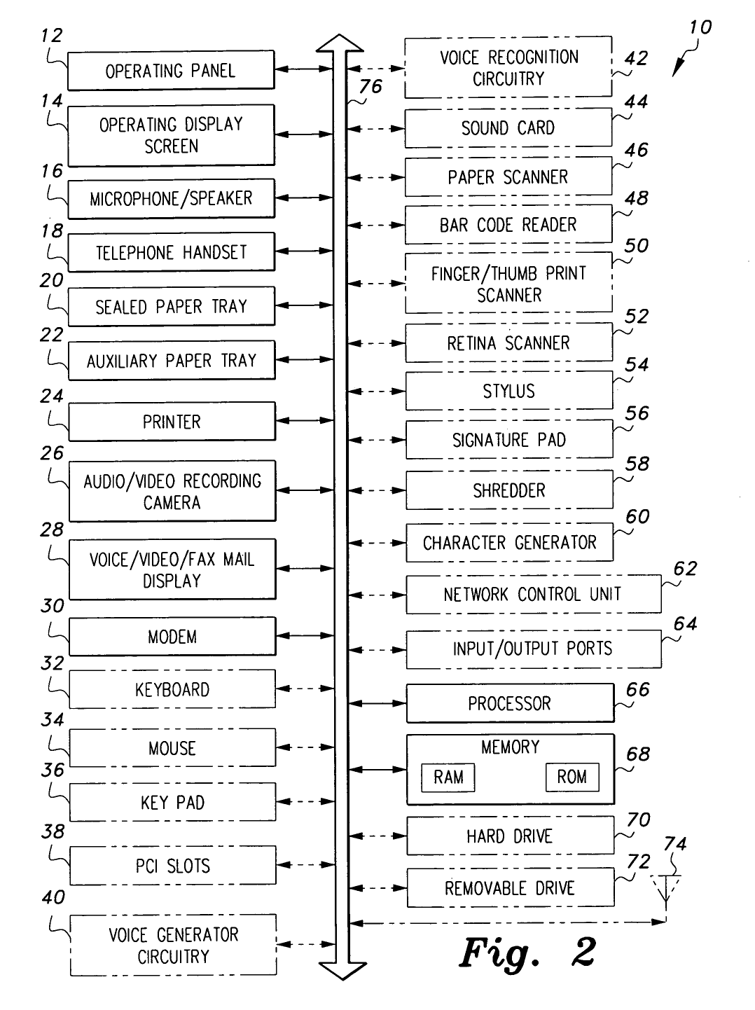

Referring to the drawings, FIGS. 1 and 2 illustrate a fax machine 10 which may be configured for transmitting and/or receiving voice/video/fax mail. As used herein voice/video/fax mail refers to any type of electronic voice messaging (voice mail), electronic video messaging, and/or fax messaging (fax mail).

The fax machine 10 is configured to communicatively interconnect with any known fax machine and execute any of a variety of conventional fax machine functions. However, the fax machine 10 also includes inventive capabilities not found on conventional fax machines, particularly when the fax machine 10 is communicatively interconnected with another fax machine 10′. The fax machine 10 may be communicatively interconnected to a telephone line or, optionally, a cable line, a digital subscriber line, a satellite, fiber optics, or the like, and electrically interconnected to a power line, such as a utility line or the like. The fax machine 10 may also be communicatively interconnected with one or more computers 80, that may each include a monitor 82, keyboard 84, mouse 86, etc. The computer 80 may be any type of computer, such as an IBM PC, a Macintosh computer, an IBM compatible computer, or the like. The fax machine 10 is powered by normal commercial or residential office distribution power and is connected to the office or residential voice telephony and/or Local Area Network/Wide Area Network (LAN/WAN) system.

The fax machine 10, as shown in FIG. 1, includes an operating panel 12, an operating display screen 14, a microphone/speaker 16, a telephone handset 18, a sealed paper tray 20, an auxiliary paper tray 22, a printer 24, an audio/video recording camera 26, a voice/video/fax mail display monitor 28, and a modem 30. An optional operational alphanumeric keyboard 32 and/or a mouse 34 may be interconnected with the fax machine 10. Interconnection of a mouse 34 to the fax machine would enable a user of the fax machine 10 to effect functions of the fax machine 10 in a manner similar to the use of a mouse with a computer. In this instance, a user of the fax machine 10 could utilize the mouse 34 and move and point to positions and/or icons on the voice/video/fax display 28. Upon positioning the mouse 34 at a desired location, the user could click and activate a function corresponding to a selected icon or the like.

The operating panel 12 may include LCD controls and the voice/video/fax display 28 may be an LCD, cathode ray tube (CRT), or plasma video display monitor, or the like. The sealed paper tray 20 is preferably a sealed transparent document reception holder. The audio/video recording camera 26 is configured to record any voice/video/fax mail transmission/reception from the fax machine 10. The fax machine 10 may be configured for being accessed via a LAN/WAN or other universal data port (see PCI slots 38 in FIG. 2) by a computer or other similar device for programming, control, and document view.

The audio/video recording camera 26 is configured for viewing any fax mail a sender wishes to see/hear before physically and/or electronically releasing from the fax machine 10. The recording camera 26 may also record picture and sound. This feature achieves full potential when the fax machine 10 is networked with another fax machine 10. For example, if a user of a sending fax machine 10 wanted to enter into an agreement/contract with a receiver at an interconnected remote fax machine 10, the sender can have the receiver read the transmitted voice/video/fax mail, e.g., the agreement/contract, and tell the sender that they agree with the agreement/contract.

As shown in FIG. 2, the fax machine 10 also includes a processor 66, memory 68, and a communication bus 76 which interconnects all of the elements of the fax machine 10. The processor 66 is either shared or dedicated hardware, including but not limited to, hardware capable of executing software. The memory 68 includes random access memory (RAM) and read only memory (ROM). The RAM may include volatile and non-volatile RAM and is capable of storing a large amount of information, and the processor 60 is designed to function uniquely as detailed below. The ROM may store programs such as Basic Input Output System (BIOS), POST, and programs to control input/output operations of hardware items, such as a keyboard, floppy disk drives, or the like. The fax machine 10 may also receive a network card for connecting to a LAN.

The fax machine 10 may also include an additional key pad 36, PCI slots 38, voice generator circuitry 40, voice recognition circuitry 42, a sound card 44, a paper scanner 46, a bar code reader 48, a finger/thumb print scanner 50, a retina scanner 52, a stylus pen 54, a signature pad 56, a shredder 58, a character generator 60, a network control unit 62, input/output ports 64, a hard drive 70, a removable drive 72, and/or an antenna 74.

The voice generator circuitry 40 may retrieve digitally encoded messages saved in the memory of the fax machine 10 and relay them to a user of the fax machine 10 via the microphone/speaker 16 or telephone handset 18. The microphone/speaker 16 enables interconnected parties using fax machines 10 to obtain a total voice/image recorded transaction between the fax machines 10. The voice recognition circuitry 42 enables the fax machine 10 to authenticate proper recipients at the fax machine 10.

The sound card 44 may be a conventional sound card and is used for storing, sending, and/or receiving voice mail. Such a sound card typically includes a digital signal processor (DSP), a digital to analog converter (DAC), an analog-to-digital converter (ADC), a read-only-memory (ROM) or Flash memory for storing data, musical instrument digital interface (MIDI) for connecting to external music, jacks for connecting speakers and microphones, as well as line in and line out, a game port for connecting a joystick or gamepad. The sound card 44 can play pre-recorded sound, record audio in various media from external sources (microphone or tape player), synthesize sound, process existing sounds. The DAC and ADC provide the means for getting the audio in and out of the sound card while the DSP oversees the process. The DSP also takes care of any alterations to the sound. The rest of the process is processed by the processor 66 of the fax machine 10.

The sound cards may be connected to headphones, speakers, microphone, radio, a digital audiotape (DAT), a CD-ROM drive, etc. The sound card receives a continuous, analog-waveform input signal from the microphone jack. The analog signals received vary in both amplitude and frequency. The sound card software selects which input(s) are used. The waveform signal is processed in real-time by an analog-to-digital converter (ADC). The digital output from the ADC flows into the DSP. The DSP is programmed by a set of instructions stored on another chip on the sound card. The DSP also allows the processor to perform other tasks while this is taking place. The DSP sends the waveform to the processor 66. The digital data is processed by the processor 66 and sent to the memory 68 or hard drive 70. To listen to a prerecorded wave file, the process is simply reversed. The digital data is read from the hard drive or memory and passed on to the processor 66. The processor 66 passes the data to the DSP on the sound card. The DSP decompresses the digital data. The decompressed, digital data stream from the DSP is processed in real-time by a DAC circuit chip, creating an analog signal that may be heard with headphones or through speakers, depending on which is connected to the sound-card's headphone jack.

The shredder 58 is configured to enable the fax machine 10 to destroy any fax document received by the fax machine 10 to prevent a disapproved/damaged/misaligned fax document from falling into the wrong hands and compromising proprietary information or someone's signature. The shredder 58 may also enable a sender to destroy any fax mail which he/she feels may not have met the standards of accuracy and/or fails to meet particular security steps of the fax machine 10.

The signature pad 56 includes an electromagnetic digitizer that provides uncompressed and/or compressed digital signature signals to be generated, transmitted, and printed on a voice/video/fax mail. The signature pad 56 includes a top portion and a bottom portion. The signature pad 56 may include an alignment guide to properly position a signature generated by a user of the signature pad 56 to properly position a signature on a voice/video/fax mail.

A stylus 54 may be used to sign the signature pad 56. The stylus includes electronic circuitry and forms a part of the digitizer circuit. The stylus 54 is connected to the signature pad 56 by a stylus cable. When the stylus 54 is not in use, it may be stored in an appropriately configured receptacle. The signature pad 56 may also be configured in the form of a full size of paper to enable users in a contract transaction to initial any changes to an agreement/contract that may be made.

The fax machine 10 includes fax software stored in the memory 68 of fax machine 10. The fax software includes a plurality of fax machine instructions which may be stored and/or transferred to the memory 68 from any computer useable medium according to the desires of the user, such as a computer hard drive 70, a removable drive (floppy disk, CD ROM, etc.) 72, Flash memory, electrically eraseable and programmable read only memory (EEPROM), optical memory, magnetic media memory, or the like, through a PC interface. The fax software is read and processed by processor 66, and causes processor 66 to perform programmed functions. Movement and process of instructions as well as data is controlled and accomplished by processor 66. The fax software includes instructions for causing the processor 66 to recognize voice/video/fax mail content information.

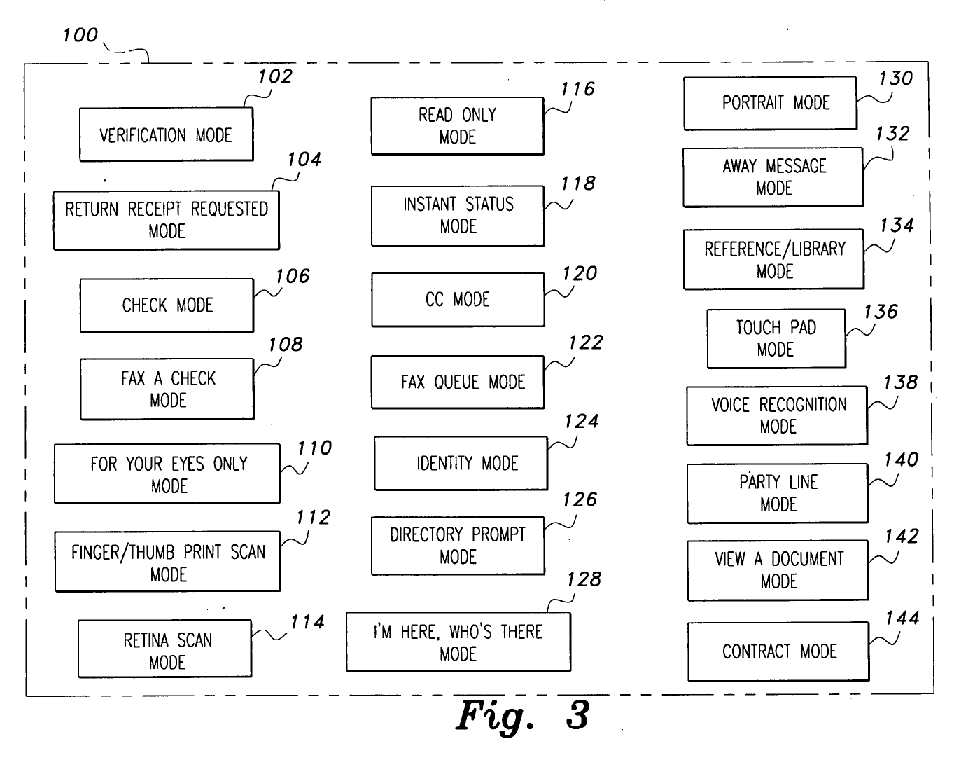

The fax software enables the fax machine 10 to be configured in a variety of modes. As shown in FIG. 3, a number of modes 100 in which the fax software may configure fax machine 10 include a VERIFICATION MODE 102, a RETURN RECEIPT REQUESTED MODE 104, a CHECK mode 106, a FAX A CHECK mode 108, a FOR YOUR EYES ONLY mode 110, a FINGER/THUMB PRINT SCAN mode 112, a RETINA SCAN mode 114, a READ ONLY mode 116, an INSTANT STATUS mode 118, a CARBON COPY (CC) mode 120, a FAX QUEUE mode 122, an IDENTITY mode 124, a DIRECTORY PROMPT mode 126, an I'M HERE, WHO'S THERE (IHWT) mode 128, a PORTRAIT mode 130, an AWAY MESSAGE mode 132, a REFERENCE/LIBRARY mode 134, a TOUCH PAD mode 136, a VOICE RECOGNITION mode 138, a PARTY LINE mode 140, a VIEW A DOCUMENT mode 142, and a CONTRACT mode 144. A user of the fax machine 10 could utilize an interconnected mouse 34 and observe on the voice/video/fax display 28 a listing of any available modes on the fax machine 10. Upon positioning the mouse 34 on a particular icon associated with a desired available mode, the user could click and activate the particular icon and activate the corresponding mode.

The VERIFICATION MODE 102 enables a user to determine whether a voice/video/fax mail sent from a fax machine 10 has been retrieved by a recipient at a receiving fax machine 10. The RETURN RECEIPT REQUESTED MODE 104 enables a user to receive a RETURN RECEIPT REQUESTED update automatically with every voice/video/fax mail sent to a receiving fax machine 10. The CHECK mode 106 enables a user to rapidly make a determination whether voice/video/fax mail sent from a fax machine 10 has been retrieved by recipients at associated retrieving fax machines 10. The FAX A CHECK mode 108 enables a user to securely fax monetary checks, such as paychecks, check payments, etc.

The FOR YOUR EYES ONLY mode 110 enables a user to configure the fax machine 10 for allowing the viewing party to see a “read only” transfer. The FINGER/THUMB PRINT SCAN mode 112 enables a user to verify the authenticity of the intended recipient via a finger/thumb print scan. The RETINA SCAN mode 114 enables a user to verify the authenticity of the intended recipient via a retina scan. The READ ONLY mode 116 enables a user to configure the fax machine 10 for allowing users to only hear/read voice/video/fax mail. The INSTANT STATUS mode 118 enables a user to be automatically notified if a voice/video/fax mail has been received at his/her fax machine 10.

The CARBON COPY (CC) mode 120 enables a user to have assurance that a voice/video/fax mail has been initiated by CC'ing a tracking number of the voice/video/fax mail back to the sending fax machine 10. The FAX QUEUE mode 122 provides the fax machine 10 with a fax queue which places incoming calls in a first come first serve basis, and provides incoming callers (e.g., senders) with a prompt indicating an approximate time the receiving fax machine 10 will receive a particular senders' voice/video/fax mail.

The IDENTITY mode 124 enables a user to ascertain whether the fax machine 10 he/she has contacted is an intended target fax machine 10. The DIRECTORY PROMPT mode 126 enables a user using the fax machine 10 to prompt an interconnected receiving fax machine 10 for a directory of extension numbers available at the receiving fax machine 10. The IHWT mode 128 enables users of fax machines 10 to communicate in a manner similar to instant messaging and/or email. The PORTRAIT mode 130 enables a fax machine equipped with a camera to provide users with images of senders and/or receivers, plus voice/video/fax mail, or images of persons or things (e.g., live feed). The AWAY MESSAGE mode 132 enables an away message, such as ‘on vacation’, ‘out sick’, etc., to be placed on a receiving fax machine 10 to enable senders to know that a particular individual at the receiving fax machine 10 is not present at a particular time to receive voice/video/fax mail. The REFERENCE/LIBRARY mode 134 enables the fax machine 10 to allow internal and/or external access to a storage database in the fax machine 10 containing voice/video/fax information that a company/business would want available to employees/customers of the company/business. For example, a company/business price sheet could be stored with an extension number to be retrieved by sales personnel of the company/business and which could be automatically restored for future reference. The storage capability could also store voice/sound and/or video.

The TOUCH PAD mode 136 enables a fax machine 10 to be configured with and to activate a full size touch pad to allow participants to instant message (IM) in script versus type. A sender may send a scripted note to a personal extension number for future retrieval. Script has its advantages when it comes to expressing oneself. The VOICE RECOGNITION mode 138 enables a fax machine 10 to be configured to match an intended receiver with a previously stored library of voices before transmitting a voice/video/fax mail. Every human voice has unique and distinctive characteristics. If voice recognition is required (for added security) for voice/video/fax mail, a fax machine 10 may be programmed to match intended receiving fax machines 10 previously stored with a library of voices before transmitting any voice/video/fax mail.

The PARTY LINE mode 140 enables a transmitting fax machine 10 to be communicatively connected to plural receiving fax machines 10 via a party line (e.g., similar to when a conference call is placed on a telephone so a caller can communicate with plural individuals/parties at different telephone numbers). The VIEW A DOCUMENT mode 142 enables a fax machine 10 to be configured to enables fax machine 16 to determine whether the sender of a fax transmission requires previewing of an image of the fax transmission prior to electronically and/or physically releasing delivery of the fax transmission to a receiving fax machine 10.

The CONTRACT mode 144 enables a sender and a receiver of a fax transmission of a contract, agreement, understanding, or the like, requiring signatures from both parties (e.g., the sender and the receiver) to view the signatures of the sender and the receiver at transmitting and receiving fax machines 10 at both ends of the fax transmission. The CONTRACT mode 144 may also enable both the sender and the receiver to print out duplicate copies of the executed contract, agreement, understanding, or the like (e.g., signed by both parties), and enable both the sender and the receiver to view the printed out duplicate copies of the executed contract, agreement, understanding, or the like. The CONTRACT mode may also be used in conjunction with the PARTY LINE mode to enable the transmitting fax machine 10 to be communicatively connected to plural receiving fax devices 10 via a party line. In the case of multiple transmitting and receiving fax machines 10 communicatively interconnected in CONTRACT mode and PARTY LINE mode, each transmitting and receiving fax machine 10 may be configured with split screen technology to enable each participating party to view the electronic and/or printed images of a fax transmission of a contract, agreement, understanding, or the like that is present at the location of each participating party. The modes may be combined on a fax machine 10.

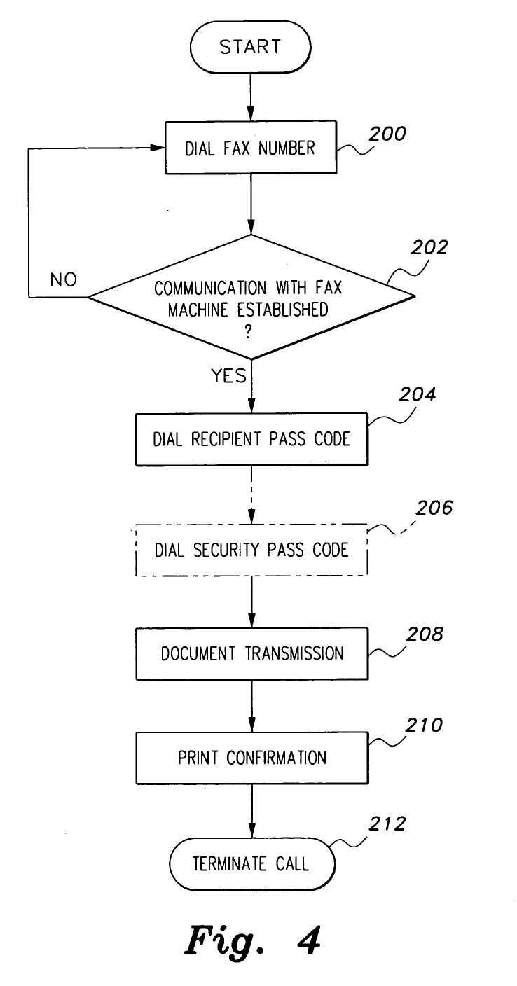

FIG. 4 shows the method involved in sending and routing voice/video/fax mail to a particular recipient where at least the recipient of the voice/video/fax mail is using a fax machine 10 as shown in FIGS. 1 and 2. A user intending to send a voice/video/fax mail (e.g., a sender) dials the fax number (step 200) of a receiving fax machine 10 and waits for the receiving fax machine 10 to answer the sender's signal. Once the signal is confirmed (step 202) the sender has several seconds to dial an extension number (recipient pass code (step 204)). The recipient pass code is a number or identifier preassigned to a particular user of the receiving fax machine 10.

The sender may dial a security pass code (step 206) designated for a particular voice/video/fax mail after dialing the recipient pass code designating a recipient. The transmitted voice/video/fax mail is then not accessible without first entering both the recipient pass code and the security pass code. This security pass code is assigned by the sender of the voice/video/fax mail and is communicated to the recipient before the recipient may access the voice/video/fax mail. This enhances the security of the transaction.

Once the pass code and/or the security code has been entered the sender transmits his/her voice/video/fax mail (ordinarily by pressing the send button on the transmitter (step 208)) and the voice/video/fax mail is stored in a memory location designated for that particular pass code. If no pass code is received the transmitted voice/video/fax mail is held in a memory location designated for unassigned voice/video/fax mail. After the voice/video/fax mail is sent the sender's fax machine 10 prints a confirmation and/or stores the confirmation in memory (step 210) and terminates the call (step 212).

The sending fax machine 10 may be configured to automatically assign a pass code to any sent voice/video/fax mail and transmit this code to the receiving fax machine 10. The receiving fax machine 10 then stores this code along with the voice/video/fax mail. Additionally, the pass code may be printed in visible or invisible ink onto the face of all sent voice/video/fax mail along with other standard information such as a date, a tracking number, a receiver's fax number, a time, or the like.

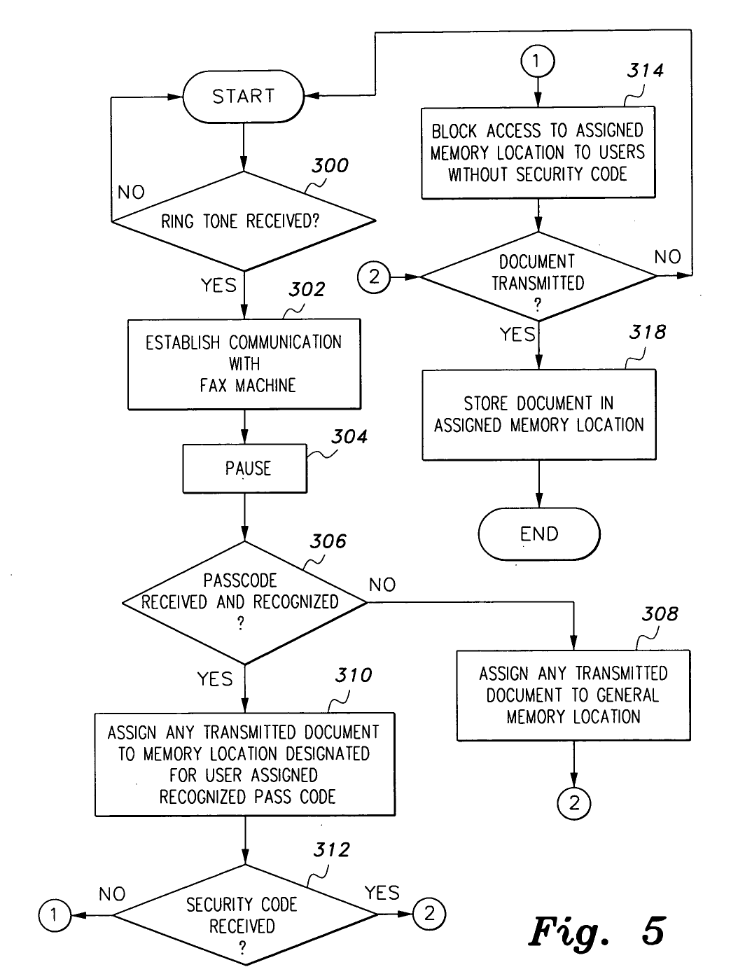

FIG. 5 illustrates the steps involved when the sending fax machine 10 has assigned a pass code to any sent voice/video/fax mail and transmits this code to the receiving fax machine 10. The processor 66 waits for a ring tone and then attempts to establish communication with an external fax machine 10 (step 300). Once communication is established (step 302) the processor 66 pauses for a predetermined amount of time and listens for a pass code (step 304). If a pass code is not received (step 306) the processor 66 assigns and stores the voice/video/fax mail in a general memory location (step 308). Any transmitted voice/video/fax mail may be saved in this memory location and may be accessed by any user.

If a pass code is received and recognized (step 306), the processor 66 designates a registry in the memory for the user that corresponds to the pass code (step 310). If a security code is then received (step 312), the processor 66 blocks access to any information faxed following the security code. Any voice/video/fax mail is then stored in the previously created memory registry.

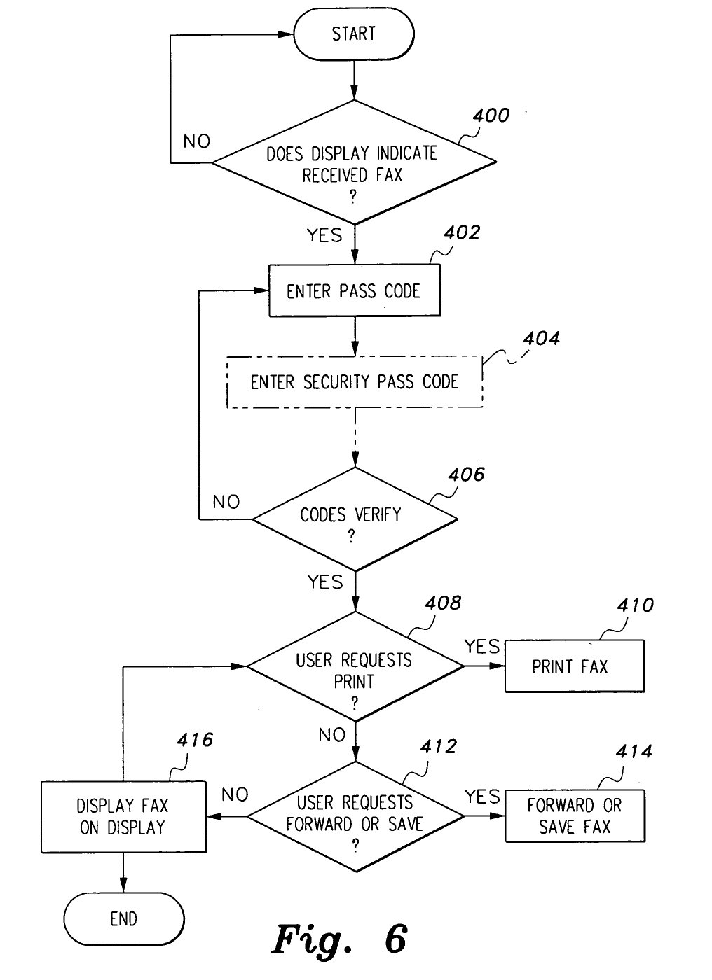

FIG. 6 illustrates the steps involved in retrieving a voice/video/fax mail. To retrieve a voice/video/fax mail, a receiving party views voice/video/fax mail display 28 to determine whether a voice/video/fax mail has been received (step 400). A recipient pass code entered by the fax sender may be converted into a text name by the processor 66. This information may be preprogrammed. For example, number 1254 may be converted into a position title such as Docket Manager, or to an employee's name, such as Bob Smith.

If a voice/video/fax mail is present the receiving party then enters his/her recipient pass code (step 402), which may be verified by the processor 66. If any of the voice/video/fax mail has security codes the receiving party may have to enter the security code for each secure voice/video/fax mail (step 404). If the recipient code is inaccurate the fax machine 10 waits until an accurate recipient code is entered by the recipient. If the recipient and/or security codes are accurate (step 408) the receiving party may then request that the voice/video/fax mail be printed (step 408), or request that the voice/video/fax mail be forwarded to an interconnected computer (step 410). The voice/video/fax mail may be displayed on the voice/video/fax mail display 28 as a default (step 416), or the voice/video/fax mail may be saved in the fax machine 10 and be accessed by any interconnected computer on the network connection.

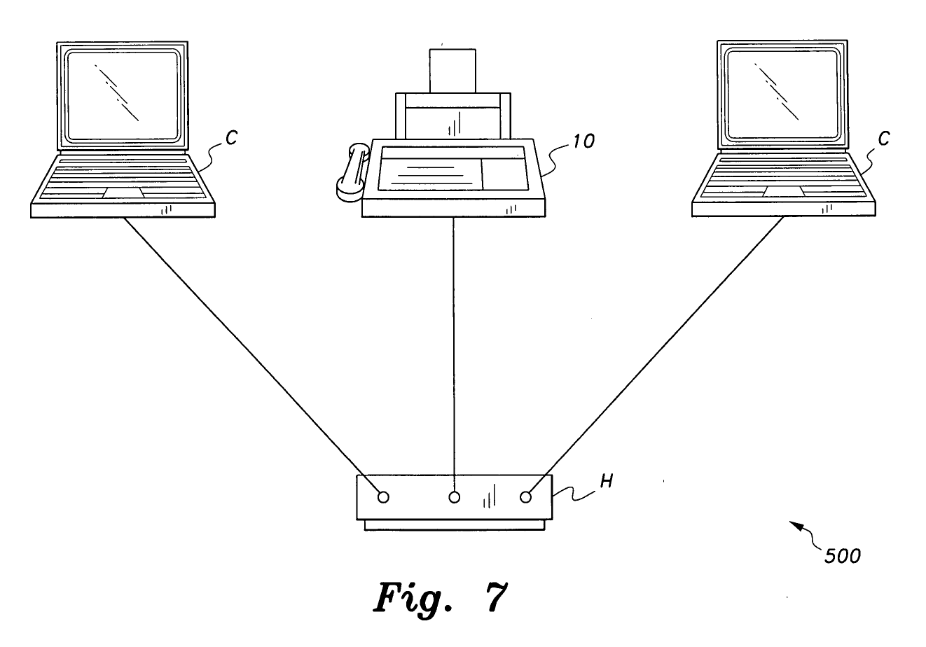

A voice/video/fax mail may be retrieved through any type of external computer attached to a LAN or WAN. In such a situation, as shown in FIG. 7, the processor 66 in fax machine 10 communicates with a network connection H through a network card inserted into fax machine 10. From there voice/video/fax mail may be routed to external computers C. The procedure for checking for voice/video/fax mail is the same as described above except that a receiving party at an interconnected computer would have the option of storing the voice/video/fax mail in the computer's memory, deleting, and/or printing the voice/video/fax mail from an interconnected printer.

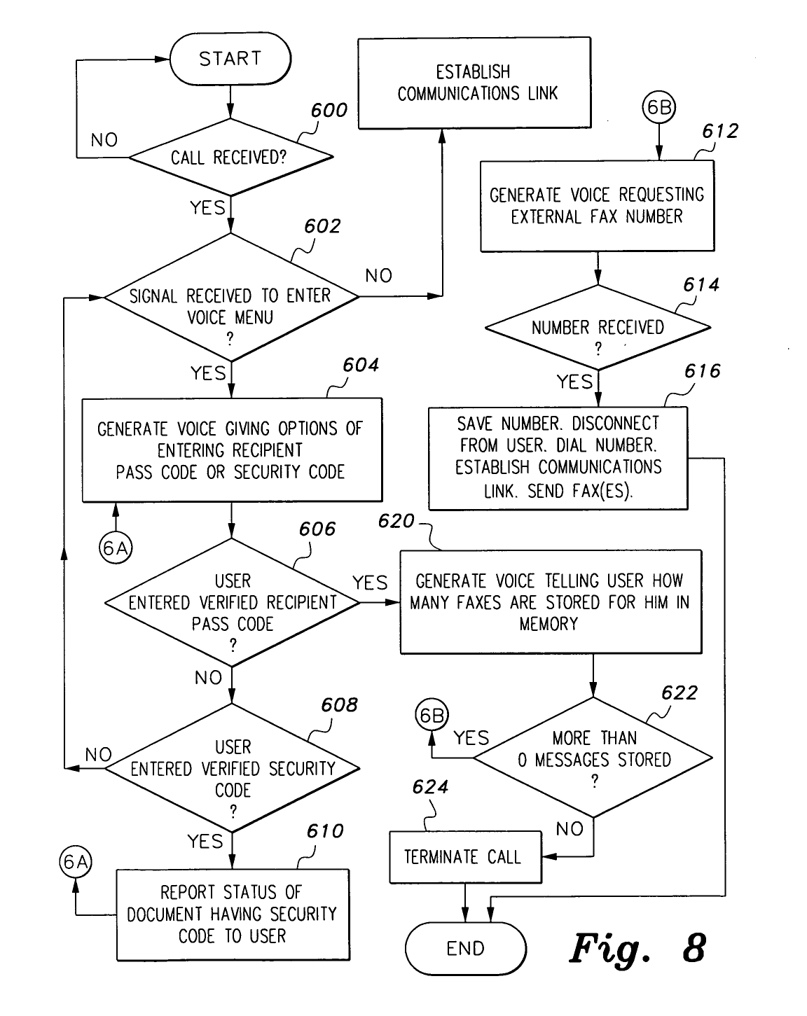

As shown in FIG. 8, fax machine 10 may also have remote access capabilities. A user may access fax machine 10 from a remote location in order to forward voice/video/fax mail in the memory or check on the context of voice/video/fax mail sent to fax machine 10.

Remote accessing of fax machine 10 involves a remote access user (remote user) first calling fax machine 10 and waiting for fax machine 10 to attempt to establish a communications link ((step 600), (step 602)). At this point the remote user may signal fax machine 10 to cease attempts at establishing a communications link with a remote fax machine 10 by pressing a predetermined key, such as the pound (#) key, or the like. The voice generator circuitry 40 may then generate a voice options menu giving the remote user options to either enter a routing pass code or a security pass code (step 604).

When a remote user selects to enter a pass code (step 606), a security pass code, or the like, the processor 66 verifies the code (step 608) and relays to the remote user how much voice/video/fax mail is present in memory assigned to that particular pass code (step 610). If voice/video/fax mail is present the user may dial the number of a remote fax machine 10. Fax machine 10 then dials and sends any voice/video/fax mail saved under that routing code to the remote fax machine 10 (steps 612, 614, 616, 620, 622, 624).

Fax machine 10 also allows a fax sender to access a recipient fax machine 10 in order to determine whether a particular voice/video/fax mail has been received and accessed by the intended recipient. This enables the sender to verify and confirm voice/video/fax mail retrieval on the recipient's fax machine 10 by way of a muted ring. The sender may access the recipient, and discreetly verify not only that the voice/video/fax mail has been received, but also that the recipient has indeed retrieved the voice/video/fax mail. Since a passcode may be used on all private mail, fax machine 10 may enable the sender to call the receiver's fax machine 10, dial in the passcode plus a specified voice/video/fax mail transmission number, and fax machine 10 may confirm whether the voice/video/fax mail has been received, or is pending retrieval. This feature has value on all systems set up employing the teachings of the invention, and particularly in the case of intracompany correspondence. A visible or invisible transmission number may appear on the face of all outgoing voice/video/fax mail, along with other standard information, such as the date, receiver's fax number, or the like.

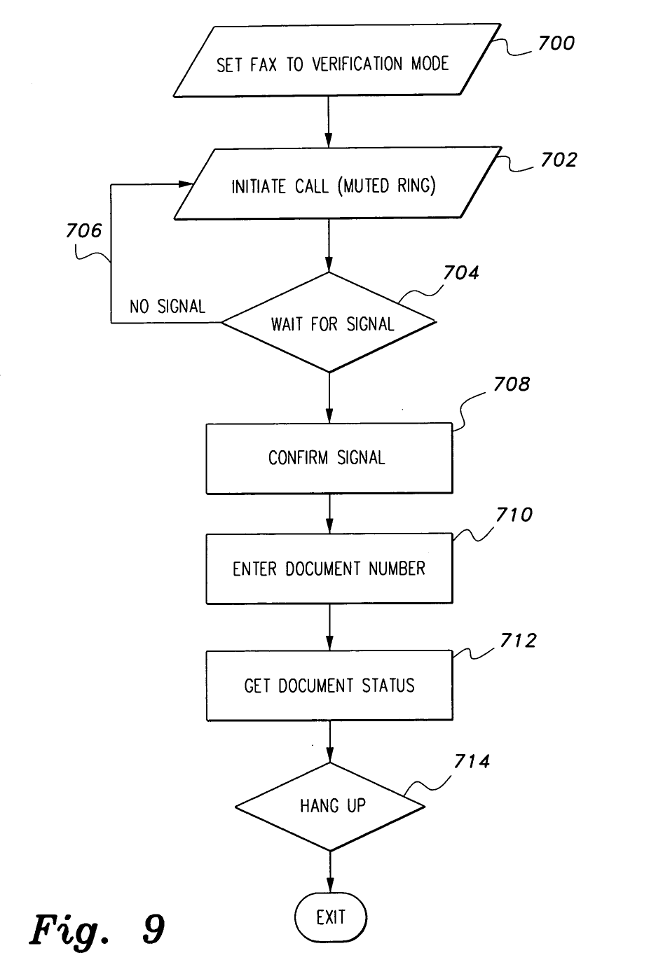

As shown in FIG. 9, fax machine 10 may be configured in a VERIFICATION mode. When voice/video/fax mail has been sent and when fax machine 10 is set to a VERIFICATION mode (step 700), a muted ring call is made (step 702), and if no signal is received (step 706), fax machine 10 waits for the signal and confirms the signal (step 704). The voice/video/fax mail tracking number is entered, the voice/video/fax mail status is retrieved, and a determination is made whether or not the voice/video/fax mail has been retrieved by the recipient, or is still pending retrieval (steps 706, 710, 712, 714). Fax machine 10 may also be configured with a RETURN RECEIPT REQUESTED mode. When voice/video/fax mail is sent to a particular receiving fax machine 10 when the sending fax machine 10 is set to a RETURN RECEIPT REQUESTED mode, the sender is able to receive a RETURN RECEIPT REQUESTED update automatically with every voice/video/fax mail sent to the receiving fax machine 10.

The sender may also program in their extension number, along with the RETURN RECEIPT REQUESTED transmission, so that the next time the sending fax machine 10 communicatively interconnects with the particular receiving fax machine 10, an update such as still pending retrieval or the like, may appear each time until a receiver at the receiving fax machine 10 retrieves the associated voice/video/fax mail. At that time, all pertinent data, such as time, date, etc., is returned to the sending fax machine 10 to establish proof positive delivery of the associated voice/video/fax mail. The receiving fax machine 10 may also be configured to automatically dial back the sending fax machine 10 when the sending fax machine 10 is set to a RETURN RECEIPT REQUESTED mode and sends a voice/video/fax mail to the receiving fax machine 10. This optional feature is primarily for intracompany use and the company believes the timely communication outweighs the savings of a phone call.

Voice messages (e.g., voice mail) may be added and/or included with a voice/video/fax mail transmitted from a fax machine 10 at the time of the transmission of the voice/video/fax mail. The sender may key punch a voice mail code, then access his/her hand set and wait for a phone prompt to signal when to leave a voice mail message. The receiver of a voice/video/fax mail with a voice mail attachment is then notified by an icon plus a tracking number appearing on the preview screen. The receiver may key punch the tracking number and receive his/her voice mail attachment. Voice mail may be added to any previously sent voice/video/fax mail prior to being retrieved by a recipient. Voice mail may also be sent as a stand alone feature with no attachments and may be retrieved by any fax machine 10 or any fax machine 10 linked to a computer connection or by a telephone.

In order to access a voice mail left on a fax machine 10 by telephone, a user may key punch their extension number and be informed of how much voice mail and/or video/fax mail they have pending, and may be further prompted to save, send, and/or listen to their pending voice mail and/or retrieve pending video/fax mail as previously described.

In order to compensate for extra memory storage space voice/video/fax mail may incur to a fax machine 10, the fax machine 10 may be equipped with one or more secondary phone/DSL/cable line(s) to default any voice/video/fax mail which was not sent from the memory of the fax machine 10. For further clarification voice/video/fax mail may be configured to pass through and not be impeded by time consuming information gathering transmissions such as verifying mode transmissions, voice mail transmissions, or the like. The fax machine 10 may be instructed to default to a particular communication line(s) when the speed of a particular voice/video/fax mail is in doubt.

Delivery speed management of delivery speed maintenance of voice/video/fax mail may be enhanced by having the fax machine 10 scan hard copy documents and insert them into the memory of the fax machine 10 prior to making an electronic connection with another fax machine 10. Such delivery speed management of delivery speed maintenance of voice/video/fax mail improves the utility of the fax machine 10 because electronic transfers of voice/video/fax mail consume small amounts of connection time, for example, as opposed to time consumption involved in waiting for fax mail to scroll and be scanned by a fax machine 10 after a connection is made.

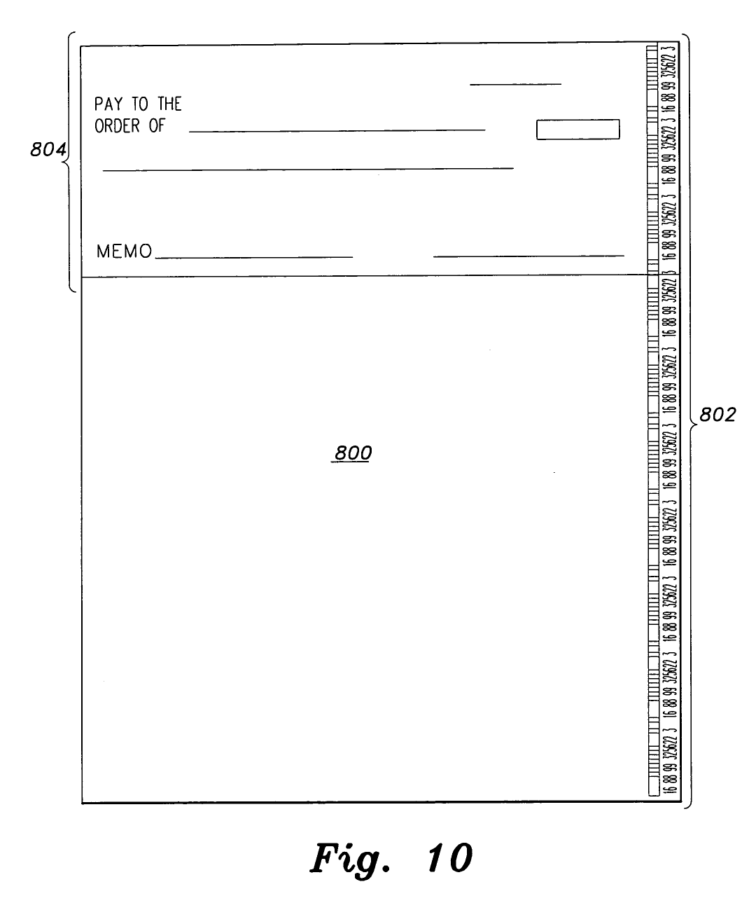

Securely faxing checks involves communication between a sending fax machine 10 and a receiving fax machine 10. Check paper may be used that contains nomenclature of a traditional check 804 in addition to some unique features. A sample piece of the aforementioned check paper 800 is illustrated in FIG. 10. The check paper 800 may be the size of a full sheet of paper so as to be easily fed through a fax machine 10. A bar code 802 may run along one side of the check paper 800 encoding a unique tracking number on printed checks. The tracking number may appear repeating alongside of the bar code 802 of the check paper 800.

The check paper 800 is a web of cellulosic fibers and may be made utilizing any known papermaking process, such as the “acidic” process, the “alkaline” process, or the like. The check paper 800 may include blends of selected species of cellulosic fibers refined to precisely defined standards, mineral and/or plastic filler pigments, dyes, sizing agents, strength-enhancing polymers, or the like, and be finished according to the desires of the user.

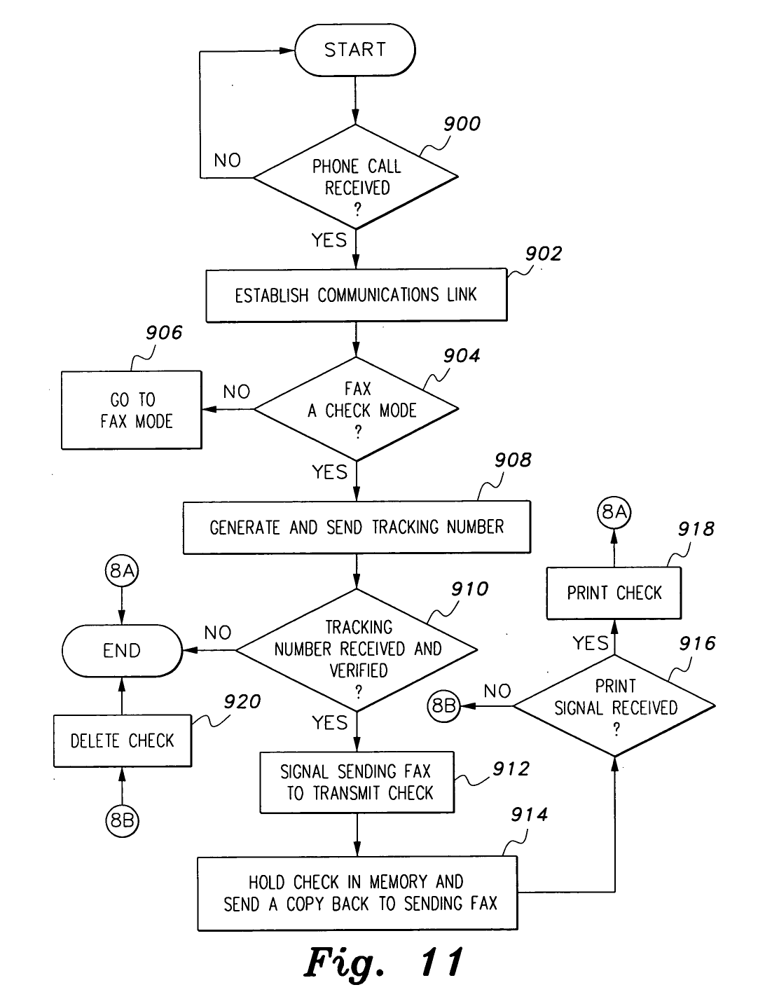

As shown in FIG. 11, a receiving fax machine 10 monitors a communications line for incoming phone calls (step 900). A communications link is established upon receipt of an incoming phone call (step 902). If the sending fax machine 10 is in a FAX A CHECK mode, it sends a fax a check signal which is detected by the receiving fax machine 10 (step 900). At that point the receiving fax machine 10 removes a sheet of check paper from the auxiliary paper tray and positions it to be scanned by the bar code reader.

The bar code reader scans the check's bar code and thereby generates a tracking number which is sent back to the sending fax machine 10 (step 908). The receiving fax machine 10 then waits a predetermined period of time to receive and verify the tracking number (step 910). If the tracking number is not received or verified before the expiration of a predetermined time limit the transaction is ended. If the tracking number is received and it matches the sent tracking number, the receiving fax machine 10 sends back a signal instructing the sending fax machine 10 to transmit the check (step 912). Any received check information is held in memory, and a copy is returned to the sending fax machine 10 (step 914). The receiving fax machine 10 then waits for a period of time for a print signal to be received from the sending fax machine 10 (step 916). Intracompany fax machines 10 may be configured to eliminate some of the security steps. For example, a check may be sent between intracompany fax machines 10 as long as the barcode reader on the receiving fax machine has scanned a properly aligned sheet of check paper. The check is printed if the signal is received (step 918), and the transaction is terminated and the check information is deleted from memory if the signal is not received (step 920).

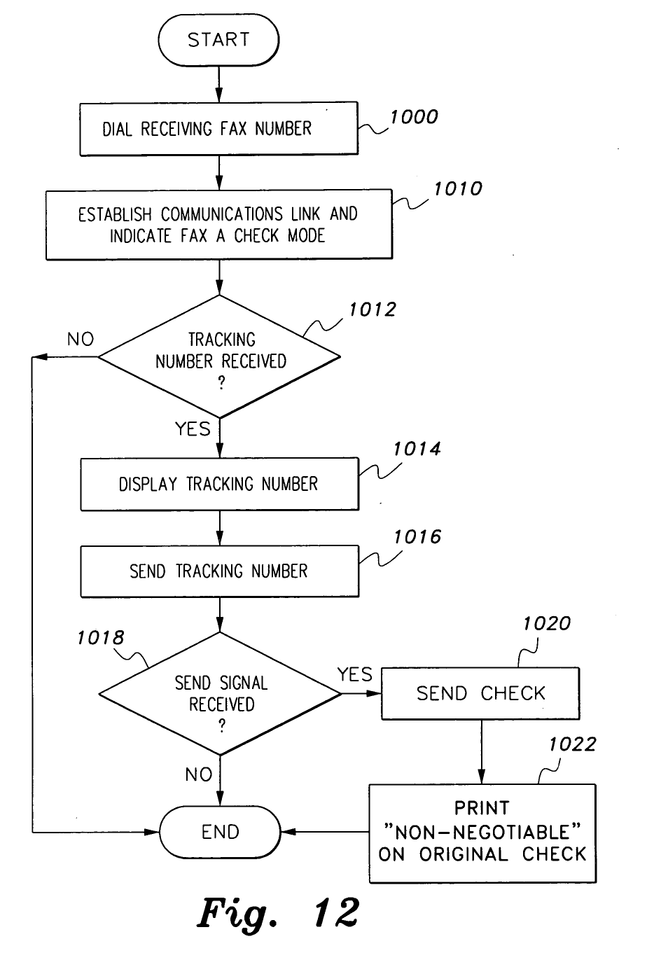

As outlined in FIG. 12, to send a check a sender dials and establishes a communication link with the receiving fax machine 10 (steps 1000, 1050). The sending fax machine 10 waits for a tracking number to be received (step 1052). If no number is received in a predetermined amount of time the transaction is terminated. If the tracking number is received the tracking number is displayed on voice/video/fax mail display 28 (step 1054). The user then types that tracking number into the operating panel 12 of the sending fax machine 10 which initiates the transmission to the receiving fax machine 10 (step 1056). If the number is verified, the receiving fax machine 10 signals the sending fax machine 10 to initiate transmission of the check. If the transmission is successful, the sending fax machine 10 sends the check (step 1020), prints a predetermined message, such as NON-NEGOTIABLE or the like, on the check (step 1022), and the transaction is terminated.

Checks and their safety may be enhanced when the fax machine 10 is in FAX A CHECK mode by having the checks sent into a secured/locked compartment of the sealed paper tray 20 of fax machine 10. In addition, the fax machine 10 may be programmed so such a secured/locked compartment of the sealed paper tray 20 does not function if the secured locked compartment is physically locked and/or by a particular code sent that activates the secured locked compartment receives a matching code from a sending fax machine 10. The fax machine may also include a mechanical folding device configured to reveal only the name on/of the check recipient to maintain the privacy of dollar amounts, etc. (e.g., for payroll checks, or the like).

Security of voice/video/fax mail via the fax machine 10 may be further enhanced by configuring the fax machine 10 for a FOR YOUR EYES ONLY mode 110, a FINGER/THUMB PRINT SCAN mode 112, a RETINA SCAN mode 114, and/or a VOICE RECOGNITION mode 138. In addition, the fax machine 10 may be configured to activate an alarm when any particular security configuration of the fax machine 10 has been breached. Such alarm activation may result in the emission of an audible sound at a predetermined decibel level, or may result in a signal transmission, wirelessly or non-wirelessly, to a remote authorized party to advise them of a breach in security protocol. The FOR YOUR EYES ONLY mode 110 involves the use of a retractable screen cover with eyeholes allowing only the viewing party to see a “read only” transfer. Initially, the screen cover is put in place on a receiving fax machine 10. When the eyes/face of a viewer and/or receiver are placed behind the screen cover and sensed by a sensor, voice/video/fax mail is activated. If the voice/video/fax mail includes an audio portion, headphones may be interconnected with the fax machine 10 to enable the user to hear the audio portion of the voice/video/fax mail as well as see the voice/video/fax mail. When the eyes/face and headphones of a viewer and/or receiver are removed from behind the screen cover the sensor no longer senses their presence and the voice/video/fax mail is deactivated.

The FINGER/THUMB PRINT SCAN mode 112 requires the receiver of a voice/video/fax mail to make contact with a scanning pad, which verifies the authenticity of the intended recipient. Once established, transmission of voice/video/fax mail may begin. The RETINA SCAN mode 114 requires the receiver of a voice/video/fax mail to view his/her eye retinas, which verifies the authenticity of the recipient. Once established, transmission of voice/video/fax mail may begin. The FINGER/THUMB PRINT SCAN mode 112, RETINA SCAN mode 114, and/or VOICE RECOGNITION mode 138 provide additional security for the sender of a voice/video/fax mail over the FOR YOUR EYES ONLY mode 110.

The sender may combine modes. For example, if a sender requires the FOR YOUR EYES ONLY mode 110 and the FINGER/THUMB PRINT SCAN mode 112, the receiver must activate the retractable screen cover, set his/her eyes in place, and maintain finger/thumb contact to the scanning pad to allow transmission of voice/video/fax mail. The FINGER/THUMB PRINT SCAN mode 112, RETINA SCAN mode 114, and/or the VOICE RECOGNITION mode 138 may require preloading of a library of finger/thumb scans, retina scans, and/or voice samples of any individuals using the associated fax machine 10.

Preloading of such finger/thumb scans, retina scans, and/or voice samples may be done according to the desires of the user. For example, some businesses/industries may load finger/thumb scans, retina scans, and/or voice samples of their employees into each fax machine 10 utilized by their businesses/industries, whereas other businesses/industries may load finger/thumb scans, retina scans, and/or voice samples of their employees into only receiving fax machines 10. Scanning of a finger/thumb print and/or a retina may be done for future verification of the recipient of a current voice/video/fax mail.

For example, a user may want to release a particular voice/video/fax mail to a particular recipient, and may be unable to verify the recipient's unique print features until a later time. However, such a recipient will know they are being thoroughly scrutinized and undoubtedly would not try to dodge the security system of the fax machine 10. If the FINGER/THUMB PRINT SCAN mode 112, RETINA SCAN mode 114, and/or the VOICE RECOGNITION mode 138 are required by the sender of a voice/video/fax mail, the voice/video/fax mail does not have to be sent in a read only mode, and may be printed and/or saved. These modes may pattern the FAX A CHECK mode 108 as pertaining to the reading of the bar code, which may send a transmission number, and may be required by the sender to send a check as described above. In other words, the scanned prints/retinas/voice can generate a unique number and this number can be used before transmission.

When a user is anticipating receipt of a voice/video/fax mail and/or a check transmission, the user may configure the fax machine 10 in the INSTANT STATUS mode 118. When a fax machine 10 is configured in the INSTANT STATUS mode 118, the fax machine 10 provides the user with an instant/automatic notification when a voice/video/fax mail has been received. This may be accomplished by having the extension holder key punching the INSTANT STATUS mode, entering his/her extension number, followed by entering a number he/she would like to be reached, such as a cell phone, PC, IM, land line phone, pager, etc.

If a user wants to CC and/or provide assurance that a voice/video/fax mail transmission from a fax machine 10 has been sent to a receiving fax machine 10, the user may configure the sending fax machine 10 in the CC mode 120. Once configured, the sending fax machine 10 may be programmed to generate the CC transmission first, and then provide the tracking number along with the CC recipients name on a principal's copy at the sending fax machine 10. In the case of multiple CC's, all CC's would be done prior to the principal's. Then the principal (the voice/video/fax mail recipient) would receive the tracking numbers for all of the CC's and with the use of the fax machine 10 the principal can verify these delivered CC's.

The FAX QUEUE mode 122 provides a receiving fax machine 10 with a fax queue which places incoming calls in a first come first serve basis, and provides incoming callers (e.g., senders) with a prompt indicating an approximate time the receiving fax machine 10 will receive a particular sender's voice/video/fax mail. For example, the FAX QUEUE mode 122 may cause the fax machine 10 to provide messages such as “your mail will be delivered in approximately thirty seconds”, “your mail will be delivered in approximately ten seconds”, “your mail has been delivered”, etc.

The IDENTITY mode 124 enables a user to ascertain whether a fax machine 10 he/she has contacted is an intended target fax machine 10. If a sender needs to be certain that a particular fax machine 10 he/she has contacted is indeed the intended target, he/she may put the fax machine in the IDENTITY mode 124 which will prompt a receiving fax machine 10 to give a disclosure of the owner of the receiving fax machine 10, the location, etc. either verbally or through reading on the display screen or both. If the ID is correct the sender can be confident and release/send his/her voice/video/fax mail.

The DIRECTORY PROMPT mode 126 enables a user using a sending fax machine 10 to prompt an interconnected receiving fax machine 10 for a directory of extension numbers available at the receiving fax machine 10. The available extension numbers may not be all of the available extension numbers at the receiving fax machine 10.

The IHWT mode 128 enables users of fax machines 10 to communicate in a manner similar to instant messaging or email. For example, fax machines 10 configured in IHWT mode 128 may communicate with other fax machines in a manner similar to instant messaging or email, and/or may communicate with computing devices interconnected to a local area and/or wide area network connection in a manner similar to instant messaging or email. This feature allows fax machines 10 and/or computer devices interconnected to a fax machine 10 that has engaged the IHWT mode 128, to communicate much in the same way as an instant message (IM) or email. The interconnection may be achieved with any phone/cable, local area and/or wide area network connection. A roster of all participants would reveal themselves on each users display screen allowing any person in this mode to chitchat. A company/business would stay in the company/business network verses being exposed to the Internet. Also if a message needs to get an instant response, for example an executive could find an employee/colleague of his/hers choosing rather then numerous phone calls to endless voice mail, etc. Note this feature may not have all of the proof positive delivery usually associated with fax machine 10, however this feature and its usefulness outweighs this concern.

The PORTRAIT mode 130 enables a fax machine equipped with a camera to provide users with images of senders and/or receivers of voice/video/fax mail. The fax machine 10 may be configured in a variety of ways to effect the PORTRAIT mode 130. For example, mirrors may be placed in proximity to a received fax document so the reflected image may be viewable by the receiving fax machine 10 and/or a remote fax machine 10. In addition, the camera 26 may be configured with a swivel to allow adjustment of the orientation of the camera lens.

The AWAY MESSAGE mode 132 enables an away message, such as ‘on vacation’, ‘out sick’, etc., to be placed on a receiving fax machine 10 to enable senders to know that a particular individual at the receiving fax machine 10 is not present at a particular time to receive voice/video/fax mail. The AWAY MESSAGE mode 132 can immediately alert a sender and enable the sender to access an AWAY MESSAGE stored in the fax machine 10. An AWAY MESSAGE may be stored on a fax machine 10 or may be communicatively linked to a fax machine 10 from a remote device. With the exception of the IHWT mode 128, an individual at a receiving fax machine 10 is not able to say ‘I did not get the voice/video/fax mail’.

An AWAY MESSAGE may be verbal, printed or a video. A video may be accomplished by use of a digital camera for easy loading, and a hard drive to subsidize memory. The REFERENCE/LIBRARY mode 134 may work in the same manner as described above. If for any reason a receiving fax machine 10 is not able to receive voice/video/fax mail (e.g., disconnected power, non-programmed extension number, communication link malfunction(s), etc.), a sender will be instantly notified if voice/video/fax mail cannot be delivered, thereby minimizing any timely delays of voice/video/fax mail delivery.

The REFERENCE/LIBRARY mode 134 enables a fax machine 10 to allow internal and/or external access to a storage database in the fax machine 10 containing documents/information that a company/business would want available to employees/customers of the company/business. For example, a company/business price sheet could be stored with an extension number to be retrieved by sales personnel of the company/business and which could be automatically restored for future reference. The storage capability could also store video and/or voice/sound. An interconnected mouse 34 would enable users to effect great utility in using this particular feature because a user could rapidly click on the REFERENCE/LIBRARY mode icon and select amongst a listing of available documents, such as a fax cover sheet or the like. In addition, stored documents could be programmed to provide predetermined information, such as a user's return address, so when the user enters their passcode the users return address will be automatically placed on the fax cover sheet with the date/time, etc. with the further capability of typing under the remark section (e.g., via a programmed fax editor), and the fax cover letter and information could be sent to its intended recipient.

The TOUCH PAD mode 136 enables a fax machine 10 to be configured with and to activate a full size touch pad to allow participants to IM in script versus type. A sender may send a scripted note to a personal extension number for future retrieval. Script has its advantages when it comes to expressing oneself. The VOICE RECOGNITION mode 138 enables a fax machine 10 to be configured to match an intended receiver with a previously stored library of voices before transmitting a voice/video/fax mail. Every human voice has unique and distinctive characteristics. If voice recognition is required (for added security) for voice/video/fax mail, a fax machine 10 may be programmed to match intended receiving fax machines 10 previously stored with a library of voices before transmitting any voice/video/fax mail.

The PARTY LINE mode 140 enables a transmitting fax machine 10 to be communicatively connected to plural receiving fax machines 10 via a party line (e.g., similar to when a conference call is placed on a telephone so a caller can communicate with plural individuals/parties at different telephone numbers). The VIEW A DOCUMENT mode 142 enables a fax machine 10 to determine whether the sender of a fax transmission requires previewing of an image of the fax transmission prior to electronically and/or physically releasing delivery of the fax transmission to a receiving fax machine 10. The CONTRACT mode 144 enables a sender and a receiver of a fax transmission of a contract, agreement, understanding, or the like, requiring signatures from both parties (e.g., the sender and the receiver) to view the signatures of the sender and the receiver at transmitting and receiving fax machines 10 at both ends of the fax transmission.

The CONTRACT mode 144 may also enable both the sender and the receiver to print out duplicate copies of the executed contract, agreement, understanding, or the like (e.g., signed by both parties), and enable both the sender and the receiver to view the printed out duplicate copies of the executed contract, agreement, understanding, or the like. The CONTRACT mode may also be used in conjunction with the PARTY LINE mode to enable the transmitting fax machine 10 to be communicatively connected to plural receiving fax devices 10 via a party line. In the case of multiple transmitting and receiving fax machines 10 communicatively interconnected in CONTRACT mode and PARTY LINE mode, each transmitting and receiving fax machine 10 may be configured with split screen technology to enable each participating party to view the electronic and/or printed images of a fax transmission of a contract, agreement, understanding, or the like that is present at the location of each participating party. Any and/or all of the above described modes may be combined on a fax machine 10.

The Pony Express and the Telegraph in their heyday outperformed all of their competition. The U.S. Mail has grown to be dependable yet has become antiquated in this modern fast paced world. For overnight delivery, if you think overnight is quick, and ten bucks is cheap, go for it. The fax machine up until now is at best LACKING, and the Internet, JAMMED (ads/pop-ups) AND RISKY (virus/hackers).

The fax machine 10 will work and last forever. The fax machine 10 allows the sender of voice/video/fax mail to be the controller of voice/video/fax mail, and enables the sender to be certain that voice/video/fax mail is delivered to an intended recipient using a fax machine 10 via a WAN. Just look at it this way, the fax machine 10 may be a system connected to a user's office by wire, cable, etc. so the printer at an intended recipient's location may be under the user's control, and the fax document may be secured in a glass container until the user proof reads or feels assured of delivering, or even shredding the fax mail.

Extension numbers and corresponding names in a connected LAN connection and a WAN linked to a fax machine 10 will be able to deliver voice/video/fax mail with proof, so much so that a user may feel as if the user were the mailman and placed the voice/video/fax mail in the mailbox him/herself, or the user can even chit chat (instant messaging) like they can on the Internet. If every office has a fax machine 10 then ALL offices would be linked. The fax machine 10 has endless possibilities.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A fax machine for routing voice/video/fax mail comprising a processor and memory, said fax machine being configured for routing voice/video/fax mail to associated recipients.

2. The fax machine according to claim 1, further comprising an operating panel.

3. The fax machine according to claim 1, further comprising an operating display screen.

4. The fax machine according to claim 1, further comprising a microphone/speaker.

5. The fax machine according to claim 1, further comprising a telephone handset.

6. The fax machine according to claim 1, further comprising a sealed paper tray.

7. The fax machine according to claim 1, further comprising an auxiliary paper tray.

8. The fax machine according to claim 1, further comprising a printer.

9. The fax machine according to claim 1, further comprising an audio/video recording camera.

10. The fax machine according to claim 1, further comprising a modem.

11. The fax machine according to claim 1, further comprising a keyboard.

12. The fax machine according to claim 1, further comprising a mouse.

13. The fax machine according to claim 1, further comprising a key pad.

14. The fax machine according to claim 13, wherein the operational key pad comprises a telephone key pad.

15. The fax machine according to claim 1, further comprising peripheral component interconnect slots.

16. The fax machine according to claim 1, further comprising voice generator circuitry.

17. The fax machine according to claim 1, further comprising voice recognition circuitry.

18. The fax machine according to claim 1, further comprising a sound card.

19. The fax machine according to claim 1, further comprising a voice/video/fax mail display.

20. The fax machine according to claim 1, further comprising a paper scanner.

21. The fax machine according to claim 1, further comprising a bar code reader.

22. The fax machine according to claim 1, further comprising a finger/thumb print scanner.

23. The fax machine according to claim 1, further comprising a retina scanner.

24. The fax machine according to claim 1, further comprising a stylus.

25. The fax machine according to claim 1, further comprising a signature pad.

26. The fax machine according to claim 1, further comprising a shredder.

27. The fax machine according to claim 1, further comprising a hard drive.

28. The fax machine according to claim 1, further comprising a removable drive.

29. The fax machine according to claim 1, wherein said fax machine includes fax software to configure the fax machine in a VERIFICATION MODE for enabling a user to determine whether a voice/video/fax mail sent from the fax machine has been retrieved by a recipient at a receiving fax machine.

30. The fax machine according to claim 1, wherein said fax machine includes fax software to configure the fax machine in a RETURN RECEIPT REQUESTED mode for enabling a user to receive a RETURN RECEIPT REQUESTED update automatically with every voice/video/fax mail sent to a receiving fax machine.

31. The fax machine according to claim 1, wherein said fax machine includes fax software to configure the fax machine in a CHECK mode for enabling a user to rapidly make a determination whether voice/video/fax mail sent from a fax machine has been retrieved by recipients at associated retrieving fax machines.

32. The fax machine according to claim 1, wherein said fax machine includes fax software to configure the fax machine in a FAX A CHECK mode for enabling a user to securely fax monetary checks.

33. The fax machine according to claim 1, wherein said fax machine includes fax software to configure the fax machine in a FOR YOUR EYES ONLY mode for enabling a viewing party to see/hear a “read only” voice/video/fax mail.

34. The fax machine according to claim 33, wherein said fax machine further comprises a retractable screen cover with eyeholes and the fax machine is configured in the FOR YOUR EYES ONLY mode operable to enable a viewing party to see/hear a “read only” voice/video/fax mail.

35. The fax machine according to claim 1, wherein said fax machine includes fax software to configure the fax machine in a FINGER/THUMB PRINT SCAN mode for enabling a user to verify the authenticity of an intended recipient via a finger/thumb print scan.

36. The fax machine according to claim 1, wherein said fax machine includes fax software to configure the fax machine in a RETINA SCAN mode for enabling a user to verify an authenticity of an intended recipient via a retina scan.

37. The fax machine according to claim 1, wherein said fax machine includes fax software to configure the fax machine in a READ ONLY mode for enabling a user to only hear/read voice/video/fax mail.

38. The fax machine according to claim 1, wherein said fax machine includes fax software to configure the fax machine in an INSTANT STATUS mode for enabling a user to be automatically notified if voice/video/fax mail has been received at a fax machine of the user.

39. The fax machine according to claim 1, wherein said fax machine includes fax software to configure the fax machine in a CARBON COPY (CC) mode for enabling a user to have assurance that a voice/video/fax mail has been initiated by CC'ing a tracking number of the voice/video/fax mail back to the fax machine.

40. The fax machine according to claim 1, wherein said fax machine includes fax software to configure the fax machine in a FAX QUEUE mode for providing the fax machine with a fax queue which places incoming calls in a first come first serve basis, and provides incoming callers with a prompt indicating an approximate time the fax machine will receive a particular sender's voice/video/fax mail.

41. The fax machine according to claim 1, wherein said fax machine includes fax software to configure the fax machine in an IDENTITY mode for enabling a user to ascertain whether receiving fax machine is an intended target fax machine.

42. The fax machine according to claim 1, wherein said fax machine includes fax software to configure the fax machine in a DIRECTORY PROMPT mode for enabling a user using to prompt an interconnected receiving fax machine for a directory of extension numbers available at the receiving fax machine.

43. The fax machine according to claim 1, wherein said fax machine includes fax software to configure the fax machine in an I'M HERE WHO'S THERE mode for enabling users of said fax machine to communicate in a manner similar to instant messaging or email.

44. The fax machine according to claim 43, wherein said fax machine is configured to communicate to other fax machines in a manner similar to instant messaging or email.

45. The fax machine according to claim 43, wherein said fax machine is configured to communicate to computing devices interconnected to a network connection in a manner similar to instant messaging or email.

46. The fax machine according to claim 1, wherein said fax machine includes fax software to configure the fax machine in a PORTRAIT mode for enabling the fax machine equipped with a camera to provide users with images of senders/receivers of voice/video/fax mail, or persons, or things.

47. The fax machine according to claim 1, wherein said fax machine includes fax software to configure the fax machine in a AWAY MESSAGE mode for enabling an away message to be placed on a receiving fax machine to enable senders to know that a particular individual at the receiving fax machine is not present at a particular time to receive voice/video/fax mail.

48. The fax machine according to claim 1, wherein said fax machine includes fax software to configure the fax machine in a REFERENCE/LIBRARY mode for providing internal/external access to documents/information stored in a storage database.

49. The fax machine according to claim 1, wherein said fax machine includes fax software to configure the fax machine in a TOUCH PAD mode to activate a full size touch pad to allow participants to instant message in script.

50. The fax machine according to claim 1, wherein said fax machine includes fax software to configure the fax machine in a VOICE RECOGNITION mode to enable the fax machine to match an intended receiver with a previously stored library of voices before transmitting a voice/video/fax mail.

51. The fax machine according to claim 1, wherein said fax machine includes fax software to configure the fax machine in a PARTY LINE mode to enable a transmitting fax machine to be communicatively connected to plural receiving fax machines via a party line.

52. The fax machine according to claim 1, wherein said fax machine includes fax software to configure the fax machine in a VIEW A DOCUMENT mode to enable the fax machine to determine whether a sender of a fax transmission requires previewing of an image of the fax transmission prior to electronically/physically releasing delivery of the fax transmission to a receiving fax machine.

53. The fax machine according to claim 1, wherein said fax machine includes fax software to configure the fax machine in a CONTRACT mode to enable the fax machine to enables a sender and a receiver of a fax transmission of a contract/agreement/understanding requiring signatures from both the sender and the receiver to view the signatures of the sender and the receiver at transmitting and receiving fax machines at both ends of the fax transmission.

54. The fax machine according to claim 1, further comprising check paper including a tracking number and a bar code running along one side of the check paper.

55. The fax machine according to claim 1, wherein the fax machine activates an alarm upon a breach of security of the fax machine.

56. The fax machine according to claim 55, wherein the alarm results in emission of an audible sound at a predetermined decibel level.

57. The fax machine according to claim 55, wherein the alarm results in transmission of a signal to a remote authorized party to advise them of a breach in security protocol of the fax machine.

58. A fax system comprising:
a first fax machine communicatively interconnected with a second fax machine,
said first fax machine including a processor and memory, and being configured for routing voice/video/fax mail to associated recipients; and
said second fax machine including a processor and memory, and being configured for routing voice/video/fax mail to associated recipients,
wherein said first fax machine is configured to route voice/video/fax mail to associated recipients at said second fax machine.

59. The fax system according to claim 58, wherein said first and second fax machines each further comprise an operating panel.

60. The fax system according to claim 58, wherein said first and second fax machines each further comprise an operating display screen.

61. The fax system according to claim 58, wherein said first and second fax machines each further comprise a microphone/speaker.

62. The fax system according to claim 58, wherein said first and second fax machines each further comprise a telephone handset.

63. The fax system according to claim 58, wherein said first and second fax machines each further comprise a sealed paper tray.

64. The fax system according to claim 58, wherein said first and second fax machines each further comprise an auxiliary paper tray.

65. The fax machine according to claim 58, wherein said first and second fax machines each further comprise a printer.

66. The fax system according to claim 58, wherein said first and second fax machines each further comprise an audio/video recording camera.

67. The fax system according to claim 58, wherein said first and second fax machines each further comprise a modem.

68. The fax system according to claim 58, wherein said first and second fax machines each further comprise a keyboard.

69. The fax system according to claim 58, wherein said first and second fax machines each further comprise a mouse.

70. The fax system according to claim 58, wherein said first and second fax machines each further comprise a key pad.

71. The fax system according to claim 70, wherein the key pad comprises a telephone key pad.

72. The fax system according to claim 58, wherein said first and second fax machines each further comprise peripheral component interconnect slots.

73. The fax system according to claim 58, wherein said first and second fax machines each further comprise voice generator circuitry.

74. The fax system according to claim 58, wherein said first and second fax machines each further comprise voice recognition circuitry.

75. The fax system according to claim 58, wherein said first and second fax machines each further comprise a sound card.

76. The fax system according to claim 58, wherein said first and second fax machines each further comprise a voice/video/fax mail display.

77. The fax system according to claim 58, wherein said first and second fax machines each further comprise a paper scanner.

78. The fax system according to claim 58, wherein said first and second fax machines each further comprise a bar code reader.

79. The fax system according to claim 58, wherein said first and second fax machines each further comprise a finger/thumb print scanner.

80. The fax system according to claim 58, wherein said first and second fax machines each further comprise a retina scanner.

81. The fax system according to claim 58, wherein said first and second fax machines each further comprise a stylus.

82. The fax system according to claim 58, wherein said first and second fax machines each further comprise a signature pad.

83. The fax system according to claim 58, wherein said first and second fax machines each further comprise a shredder.

84. The fax system according to claim 58, wherein said first and second fax machines each further comprise a hard drive.

85. The fax system according to claim 58, wherein said first and second fax machines each further comprise a removable drive.

86. The fax system according to claim 58, wherein said first and second fax machines each include fax software to configure the fax machine in a VERIFICATION MODE for enabling a user to determine whether voice/video/fax mail sent from the fax machine has been retrieved by a recipient at a receiving fax machine.

87. The fax system according to claim 58, wherein said first and second fax machines each include fax software to configure the fax machine in a RETURN RECEIPT REQUESTED mode for enabling a user to receive a RETURN RECEIPT REQUESTED update automatically with every voice/video/fax mail sent to a receiving fax machine.

88. The fax system according to claim 58, wherein said first and second fax machines each include fax software to configure the fax machine in a CHECK mode for enabling a user to rapidly make a determination whether voice/video/fax mail sent from a fax machine has been retrieved by recipients at associated retrieving fax machines.

89. The fax system according to claim 58, wherein said first and second fax machines each include fax software to configure the fax machine in a FAX A CHECK mode for enabling a user to securely fax monetary checks.

90. The fax system according to claim 58, wherein said first and second fax machines each include fax software to configure the fax machine in a FOR YOUR EYES ONLY mode for enabling a viewing party to hear/see a “read only” voice/video/fax mail.

91. The fax machine according to claim 90, wherein said first and second fax machines each further comprise a retractable screen cover with eyeholes and the fax machine is configured in the FOR YOUR EYES ONLY mode operable to enable a viewing party to hear/see a “read only” voice/video/fax mail.

92. The fax system according to claim 58, wherein said first and second fax machines each include fax software to configure the fax machine in a FINGER/THUMB PRINT SCAN mode for enabling a user to verify an authenticity of an intended recipient via a finger/thumb print scan.

93. The fax system according to claim 58, wherein said first and second fax machines each include fax software to configure the fax machine in a RETINA SCAN mode for enabling a user to verify an authenticity of an intended recipient via a retina scan.

94. The fax system according to claim 58, wherein said first and second fax machines each include fax software to configure the fax machine in a READ ONLY mode for enabling a user to only hear/read voice/video/fax mail.

95. The fax system according to claim 58, wherein said first and second fax machines each include fax software to configure the fax machine in an INSTANT STATUS mode for enabling a user to be automatically notified if voice/video/fax mail has been received at a fax machine of the user.

96. The fax system according to claim 58, wherein said first and second fax machines each include fax software to configure the fax machine in a CARBON COPY (CC) mode for enabling a user to have assurance that voice/video/fax mail has been initiated by CC'ing a tracking number of the voice/video/fax mail back to the fax machine.

97. The fax system according to claim 58, wherein said first and second fax machines each include fax software to configure the fax machine in a FAX QUEUE mode for providing the fax machine with a fax queue which places incoming calls in a first come first serve basis, and provides incoming callers with a prompt indicating an approximate time the fax machine will receive a particular sender's voice/video/fax mail.

98. The fax system according to claim 58, wherein said first and second fax machines each include fax software to configure the fax machine in an IDENTITY mode for enabling a user to ascertain whether receiving fax machine is an intended target fax machine.

99. The fax system according to claim 58, wherein said first and second devices each include fax software to configure the fax machine in a DIRECTORY PROMPT mode for enabling a user using to prompt an interconnected receiving fax machine for a directory of extension numbers available at the receiving fax machine.

100. The fax system according to claim 58, wherein said first and second fax machines each include fax software to configure the fax machine in an I'M HERE WHO'S THERE mode for enabling users of said fax machine to communicate in a manner similar to instant messaging or email.

101. The fax machine according to claim 100, wherein said first and second fax machines are configured to communicate to other fax machines in a manner similar to instant messaging or email.

102. The fax machine according to claim 100, wherein said first and second fax machines are configured to communicate to computing devices interconnected to a network connection in a manner similar to instant messaging or email.

103. The fax system according to claim 58, wherein said first and second fax machines each include fax software to configure the fax machine in a PORTRAIT mode for enabling the fax machine equipped with a camera to provide users with images of senders/receivers of voice/video/fax mail, or persons, or things.

104. The fax system according to claim 58, wherein said first and second fax machines each include fax software to configure the fax machine in a AWAY MESSAGE mode for enabling an away message to be placed on a receiving fax machine to enable senders to know that a particular individual at the receiving fax machine is not present at a particular time to receive voice/video/fax mail.

105. The fax system according to claim 58, wherein said first and second fax machines each include fax software to configure the fax machine in a REFERENCE LIBRARY mode for providing internal/external access to documents/information stored in a storage database.

106. The fax system according to claim 58, wherein said first and second fax machines each include fax software to configure the fax machine in a TOUCH PAD mode to activate a full size touch pad to allow participants to instant message in script.

107. The fax system according to claim 58, wherein said first and second fax machines each include fax software to configure the corresponding fax machine in a VOICE RECOGNITION mode to enable the fax machine to match an intended receiver with a previously stored library of voices before transmitting a fax/voice mail.

108. The fax system according to claim 58, wherein said first and second fax machines each include fax software to configure the corresponding fax machine in a PARTY LINE mode to enable a transmitting fax machine to be communicatively connected to plural receiving fax machines via a party line.

109. The fax system according to claim 58, wherein said first and second fax machines each include fax software to configure the corresponding fax machine in a VIEW A DOCUMENT mode to enable the associated fax machine to determine whether a sender of a fax transmission requires previewing of an image of the fax transmission prior to electronically/physically releasing delivery of the fax transmission to a receiving fax machine.

110. The fax system machine according to claim 58, wherein said first and second fax machines each include fax software to configure the fax machine in a CONTRACT mode to enable the corresponding fax machine to enables a sender and a receiver of a fax transmission of a contract/agreement/understanding requiring signatures from both the sender and the receiver to view the signatures of the sender and the receiver at transmitting and receiving fax machines at both ends of the fax transmission.

111. The fax system according to claim 58, wherein said first and second fax machines each further comprise check paper including a tracking number and a bar code running along one side of the check paper.

112. The fax system according to claim 58, wherein said first and second fax machines are each configured to activate an alarm upon a breach of security of the associated fax machine.

113. The fax system according to claim 112, wherein the alarm results in emission of an audible sound at a predetermined decibel level.

114. The fax system according to claim 112, wherein the alarm results in transmission of a signal to a remote authorized party to advise them of a breach in security protocol of the fax machine.

115. A method for routing voice/video/fax mail, the method comprising:
providing a first fax machine;
providing a second fax machine;
communicatively interconnecting the first fax machine with the second fax machine for a first voice/video/fax mail transmission;
transmitting a first voice/video/fax mail with a recipient fax code from the first fax machine to the second fax machine;
receiving the first voice/video/fax mail with the recipient 11 fax code at the second fax machine; and
controlling access to the first voice/video/fax mail from the second fax machine based on reentry of the recipient fax code at the second fax machine.

116. The method according to claim 115, further comprising providing each of the first and second fax machines with an operating panel.

117. The method according to claim 115, further comprising providing each of the first and second fax machines with an operating display screen.

118. The method according to claim 115, further comprising providing each of the first and second fax machines with a microphone/speaker.

119. The method according to claim 115, further comprising providing each of the first and second fax machines with a telephone handset.

120. The method according to claim 115, further comprising providing each of the first and second fax machines with a sealed paper tray.

121. The method according to claim 115, further comprising providing each of the first and second fax machines with an auxiliary paper tray.

122. The method according to claim 115, further comprising providing each of the first and second fax machines with a printer.

123. The method according to claim 115, further comprising providing each of the first and second fax machines with an audio/video recording camera.

124. The method according to claim 115, further comprising providing each of the first and second fax machines with a modem.

125. The method according to claim 115, further comprising providing each of the first and second fax machines with a keyboard.

126. The method according to claim 115, further comprising providing each of the first and second fax machines with a mouse.

127. The method according to claim 115, further comprising providing each of the first and second fax machines with a key pad.

128. The method according to claim 127, further comprising providing the key pad as a telephone key pad.

129. The method according to claim 115, further comprising providing each of the first and second fax machines with peripheral component interconnect slots.

130. The method according to claim 115, further comprising providing each of the first and second fax machines with voice generator circuitry.

131. The method according to claim 115, further comprising providing each of the first and second fax machines with voice recognition circuitry.

132. The method according to claim 115, further comprising providing each of the first and second fax machines with a sound card.

133. The method according to claim 115, further comprising providing each of the first and second fax machines with a voice/video/fax mail display.

134. The method according to claim 115, further comprising providing each of the first and second fax machines with a paper scanner.

135. The method according to claim 115, further comprising providing each of the first and second fax machines with a bar code reader.

136. The method according to claim 115, further comprising providing each of the first and second fax machines with a finger/thumb print scanner.

137. The method according to claim 115, further comprising providing each of the first and second fax machines with a retina scanner.

138. The method according to claim 115, further comprising providing each of the first and second fax machines with a stylus.

139. The method according to claim 115, further comprising providing each of the first and second fax machines with a signature pad.

140. The method according to claim 115, further comprising providing each of the first and second fax machines with a shredder.

141. The method according to claim 115, further comprising providing each of the first and second fax machines with a hard drive.

142. The method according to claim 115, further comprising providing each of the first and second fax machines with a removable drive.

143. The method according to claim 115, further comprising configuring the first and second fax machines in a VERIFICATION MODE for enabling a user to determine whether a voice/video/fax mail sent from the fax machine has been retrieved by a recipient at a receiving fax machine.

144. The method according to claim 115, further comprising configuring the first and second fax machines in a RETURN RECEIPT REQUESTED mode for enabling a user to receive a RETURN RECEIPT REQUESTED update automatically with every voice/video/fax mail sent to a receiving fax machine.

145. The method according to claim 115, further comprising configuring the first and second fax machines in a CHECK mode for enabling a user to rapidly make a determination whether voice/video/fax mail sent from a fax machine has been retrieved by recipients at associated retrieving fax machines.

146. The method according to claim 115, further comprising configuring the first and second fax machines in a FAX A CHECK mode for enabling a user to securely fax monetary checks.

147. The method according to claim 115, further comprising configuring the first and second fax machines in a FOR YOUR EYES ONLY mode for enabling a viewing party to see a “read only” transfer.

148. The method according to claim 147, further comprising configuring the first and second fax machines with a retractable screen cover with eyeholes and the fax machine is configured in a FOR YOUR EYES ONLY mode operable to enable a viewing party to hear/see a “read only” voice/video/fax mail.

149. The method according to claim 115, further comprising configuring the first and second fax machines in a FINGER/THUMB PRINT SCAN mode for enabling a user to verify an authenticity of an intended recipient via a finger/thumb print scan.

150. The method according to claim 115, further comprising configuring the first and second fax machines in a RETINA SCAN mode for enabling a user to verify an authenticity of an intended recipient via a retina scan.

151. The method according to claim 115, further comprising configuring the first and second fax machines in a READ ONLY mode for enabling a user to only hear/read voice/video/fax mail.

152. The method according to claim 115, further comprising configuring the first and second fax machines in an INSTANT STATUS mode for enabling a user to be automatically notified if voice/video/fax mail has been received at a fax machine of the user.

153. The method according to claim 115, further comprising configuring the first and second fax machines in a CARBON COPY (CC) mode for enabling a user to have assurance that voice/video/fax mail has been initiated by CC'ing a tracking number of the voice/video/fax mail back to the fax machine.

154. The method according to claim 115, further comprising configuring the first and second fax machines in a FAX QUEUE mode for providing the fax machine with a fax queue which places incoming calls in a first come first serve basis, and provides incoming callers with a prompt indicating an approximate time the fax machine will receive a particular sender's voice/video/fax mail.

155. The method according to claim 115, further comprising configuring the first and second fax machines in an IDENTITY mode for enabling a user to ascertain whether receiving fax machine is an intended target fax machine.

156. The method according to claim 115, further comprising configuring the first and second fax machines in a DIRECTORY PROMPT mode for enabling a user using to prompt an interconnected receiving fax machine for a directory of extension numbers available at the receiving fax machine.

157. The method according to claim 115, further comprising configuring the first and second fax machines in an I'M HERE WHO'S THERE mode for enabling users of the first and second fax machines to communicate in a manner similar to instant messaging or email.

158. The method according to claim 157, further comprising configuring the first and second fax machines to communicate to other fax machines in a manner similar to instant messaging or email.

159. The method according to claim 157, further comprising configuring the first and second fax machines to communicate to computing devices interconnected to a network connection in a manner similar to instant messaging or email.

160. The method according to claim 115, further comprising configuring the first and second fax machines in a PORTRAIT mode for enabling the fax machine equipped with a camera to provide users with images of senders/receivers of voice/video/fax mail, or persons, or things.

161. The method according to claim 115, further comprising configuring the first and second fax machines in an AWAY MESSAGE mode for enabling an away message to be placed on either fax machine to enable senders to know that a particular individual at the associated fax machine is not present at a particular time to receive voice/video/fax mail.

162. The method according to claim 115, further comprising configuring the first and second fax machines in a REFERENCE/LIBRARY mode for providing internal/external access to documents/information stored in a storage database.

163. The method according to claim 115, further comprising configuring the first and second fax machines in a TOUCH PAD mode to activate a full size touch pad to allow participants to instant message in script.

164. The method according to claim 115, further comprising configuring the first and second fax machines in a VOICE RECOGNITION mode to enable the fax machine to match an intended receiver with a previously stored library of voices before transmitting a fax/voice mail.

165. The method according to claim 115, further comprising configuring the first and second fax machines in a PARTY LINE mode to enable a transmitting fax machine to be communicatively connected to plural receiving fax machines via a party line.

166. The method according to claim 115, further comprising configuring the first and second fax machines in a VIEW A DOCUMENT mode to enable the associated fax machine to determine whether a sender of a fax transmission requires previewing of an image of the fax transmission prior to electronically/physically releasing delivery of the fax transmission to a receiving fax machine.

167. The method according to claim 115, further comprising configuring the first and second fax machines in a CONTRACT mode to enable the corresponding fax machine to enable a sender and a receiver of a fax transmission of a contract/agreement/understanding requiring signatures from both the sender and the receiver to view the signatures of the sender and the receiver at transmitting and receiving fax machines at both ends of the fax transmission.

168. The method according to claim 115, further comprising configuring the first and second fax machines with check paper including a tracking number and a bar code running along one side of the check paper.

169. The method according to claim 115, further comprising configuring the first and second fax machines to activate an alarm upon a breach of security of the associated fax machine.

170. The method according to claim 169, wherein the alarm results in emission of an audible sound at a predetermined decibel level.

171. The method according to claim 169, wherein the alarm results in transmission of a signal to a remote authorized party to advise them of a breach in security protocol of the fax machine.
